(19) United States
(12) Patent Application Publication
(10) Pub. No.: US 2026/0051686 A1
(43) Pub. Date: Feb. 19, 2026

(54) METHOD OF MANUFACTURING TERMINAL MODULE AND CONNECTOR ASSEMBLY

(71) Applicant: LOTES CO., LTD, Keelung (TW)

(72) Inventors: Wen-Chang Chang, Keelung (TW); Wen-Wei Lin, Guangzhou (CN); Ren-Fei Yang, Guangzhou (CN); Yuan-Cheng Lu, Guangzhou (CN); Qing-Cheng Zeng, Guangzhou (CN); Zi-Sen Wei, Keelung (TW); Yao-Ling Cheng, Keelung (TW); Shan-Ju Yang, Keelung (TW)

(21) Appl. No.: 19/027,115

(22) Filed: Jan. 17, 2025

(30) Foreign Application Priority Data
Aug. 16, 2024 (CN) 202411124773.0

(51) Int. Cl. H01R 13/405; H01R 13/66; H01R 43/24

(52) U.S. Cl. CPC H01R 13/405; H01R 13/6625; H01R 43/24

(57) ABSTRACT

A method of manufacturing a terminal module and a connector assembly having the terminal module. The terminal module includes first signal terminals and conductive terminals formed individually. Each first signal terminal includes a first body portion, a first soldering portion and a tail portion. Each conductive terminal includes a second body portion, a contact portion and a second soldering portion. The conductive terminals include second signal terminals. The first soldering portion of each signal terminal and the second soldering portion of each second signal terminal are provided to be separate and form an interval therebetween, and an electronic component is provided at the corresponding interval, without the need to cut the middle portions of the signal terminals by a cutting blade to form a broken recess, thus being convenient for the manufacturing of the terminal module, and improving the electrical characteristics of the terminal module.

### CROSS-REFERENCE TO RELATED PATENT APPLICATION

This non-provisional application claims priority to and the benefit of, pursuant to 35 U.S.C. § 119(a), patent application Serial No. CN202411124773.0, filed in China on Aug. 16, 2024. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to the field of electrical connectors, and particularly to a method of manufacturing a terminal module and a connector assembly having the terminal module.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In the connector field, to improve the electrical characteristics of the signal terminals, an electrical connector with electronic components provided on the signal terminals has emerged. The forming process of a terminal module of the connector includes: 1. Forming the signal terminals and the ground terminals by stamping. 2. Performing insert-molding, in which the signal terminals and the ground terminals are arranged as embedded components in a cavity of an insert mold, and a plastic fixing member is formed by insert-molding. Through this process, the signal terminals, the ground terminals and the plastic fixing member are formed as a single unit. 3. Providing a plurality of through holes corresponding to the signal terminals on the plastic fixing member, and removing a small section of each signal terminal in the middle of the plastic fixing member by a cutting blade through the through holes, thus forming a break, such that each signal terminal become two separate portions. 4. Providing solders at the locations in the through holes corresponding to the breaks that require soldering. 5. Soldering a first electronic component on the break, such that the two separate portions of each signal terminal are electrically connected through the first electronic component. 6. Injecting molten plastic into the internal through holes by insert-molding or adhesive dispensing, and the molten plastic, after curing, forms a plastic layer covering the first electronic component, thus forming the terminal module.

The terminal module produced by this method is relatively complex for manufacturing. After molding the terminal module, the cutting blade is required to cut the signal terminals to form the breaks, and the cutting blade needs to pass through the through holes of the plastic fixing member to cut the signal terminals. If the terminal module is not accurately positioned, the cutting blade may cut other portions of the terminal module, thus damaging the entire terminal module and increasing the costs. In addition, with the current developing technology, the terminal assembly becomes smaller, and the through holes are small, making it difficult for operation of the cutting blade.

Therefore, a heretofore unaddressed need to design a method of manufacturing a terminal module which is convenient for manufacturing and a connector assembly having the terminal module exists in the art to address the aforementioned deficiencies and inadequacies.

### SUMMARY

In view of the deficiencies of the background technology, the present invention is directed to a method of manufacturing a terminal module and a connector assembly, without the need to cut the signal terminals and being convenient for soldering the electronic component, thus allowing convenient manufacturing.

To achieve the foregoing objective, the present invention adopts the following technical solutions. A method of manufacturing a terminal module includes: S1: providing at least one first signal terminal and a plurality of conductive terminals having at least one second signal terminal, and providing at least one first plastic member and a second plastic member, wherein each of the at least one first signal terminal comprises a first body portion and a first soldering portion and a tail portion provided at two opposite ends of the first body portion, and each of the conductive terminals comprises a second body portion and a contact portion and a second soldering portion provided at two opposite ends of the second body portion; S2: mounting the first signal terminal in the first plastic member, such that the first soldering portion and the tail portion are exposed outside the first plastic member, and mounting the conductive terminals in the second plastic member, such that the second soldering portion of each of the conductive terminals is exposed outside the second plastic member; S3: connecting and fixing the first plastic member mounted with the first signal terminal and the second plastic member mounted with the conductive terminals, such that the first soldering portion of each of the at least one first signal terminal one-to-one aligns with the second soldering portion of a corresponding one of the at least one second signal terminal along a first direction, and an interval is formed between the first soldering portion and the corresponding second soldering portion; and S4: disposing each of an electronic component to correspond to one of the interval, wherein the electronic component has a first mating portion and a second mating portion, and soldering the first mating portion to the first soldering portion, and soldering the second mating portion to the second soldering portion of the corresponding one of the at least one second signal terminal.

In certain embodiments, the method further includes: providing a first metal plate and a second metal plate; stamping the first metal plate to form the at least one first signal terminal and a first strip connected to the first signal terminal; stamping the second metal plate to form the conductive terminals and a second strip connected to the conductive terminals; insert-molding molten plastic on the first signal terminal to form the first plastic member; and insert-molding molten plastic on the conductive terminals to form the second plastic member.

In certain embodiments, the method further includes: after the step S1 and prior to the step S2, breaking the first strip and the first signal terminal to remove the first strip, and breaking the second strip and the second signal terminal; and by positioning of the second strip, assembling the first plastic member with the first signal terminal to the second plastic member with the conductive terminals and the second strip, then soldering the electronic component between the first soldering portion and the second soldering portion of the corresponding one of the at least one second signal terminal, and finally breaking the second strip and the remaining conductive terminals to remove the second strip.

In certain embodiments, the method further includes: assembling the first plastic member with the first signal terminal to the second plastic member with the conductive terminals, such that the second soldering portion of the second signal terminal is disposed on the first plastic member.

In certain embodiments, the first plastic member is provided with at least one positioning recess, and in the step S2, the second soldering portion of the second signal terminal protrudes into the positioning recess, such that the second soldering portion of the second signal terminal aligns with the corresponding first soldering portion in the first direction.

In certain embodiments, the second plastic member is provided with at least one opening, the opening runs through a side of the second plastic member along a second direction, the second direction is perpendicular to the first direction, each of the at least one opening is provided to correspond to the interval in the second direction, such that the first soldering portion and the second soldering portion of the corresponding one of the at least one second signal terminal are exposed in the corresponding opening, and the electronic component is disposed in the opening.

In certain embodiments, in the step S1, the conductive terminals further have a plurality of ground terminals correspondingly provided at two opposite sides of the at least one second signal terminal, the ground terminals extend to pass beyond the second soldering of the second signal terminal and extend toward the first signal terminal to an adjacent side of the first signal terminal; and in the step S4, at least one electrostatic discharge protection component is provided, and each of the at least one electrostatic discharge protection component is soldered to a corresponding one of the at least one first signal terminal and one of the ground terminals adjacent to the corresponding one of the at least one first signal terminal.

In certain embodiments, the method includes: providing a plurality of pairs of first signal terminals and a plurality of pairs of second signal terminals, wherein each pair of the first signal terminals and a corresponding pair of the second signal terminals are configured to transmit differential signals, each pair of the first signal terminals are insert-molded with molten plastic to form one of the first plastic members, and each of the first plastic members is assembled to the second plastic member.

In certain embodiments, the method further includes: providing a plurality of first wires, wherein after soldering the electronic component to the first soldering portion and the corresponding second soldering portion, the first wires are soldered to the tail portion of the first signal terminal.

The present invention further provides a connector assembly, which includes: a housing; and a terminal module, provided in the housing. The terminal module comprises: at least one first signal terminal and a plurality of conductive terminals comprising at least one second signal terminal and a plurality of ground terminals, wherein the first signal terminal and the second signal terminal are formed individually, each of the at least one first signal terminal comprises a first body portion and a first soldering portion and a tail portion provided at two opposite ends of the first body portion, and each of the conductive terminals comprises a second body portion and a contact portion and a second soldering portion provided at two opposite ends of the second body portion; a plastic seat, wherein the first signal terminal and the second signal terminal are both mounted in the plastic seat, the first soldering portion of the first signal terminal aligns with the second soldering portion of a corresponding one of the at least one second signal terminal, and an interval is formed between the first soldering portion and the corresponding second soldering portion; and at least one electronic component, correspondingly provided at one of the interval, wherein the electronic component has a first mating portion and a second mating portion, the first mating portion is soldered to the first soldering portion, and the second mating portion is soldered to the second soldering portion.

In certain embodiments, the plastic seat is provided with at least one positioning recess; the plastic seat comprises at least one first plastic member and a second plastic member mounted to each other, the first signal terminal is provided in the first plastic member by insert-molding, and the conductive terminals are provided in the second plastic member by insert-molding; and the positioning recess is formed on the first plastic member, and the second soldering portion of each of the at least one second signal terminal one-to-one correspondingly protrude into a corresponding one of the at least one positioning recess; or the positioning recess is formed on the second plastic member, and the first soldering portion of each of the at least one first signal terminal one-to-one correspondingly protrude into a corresponding one of the at least one positioning recess.

In certain embodiments, the plastic seat is provided with one of a plurality of separation blocks corresponding to each of the intervals, each of the separation blocks protrudes into a corresponding one of the intervals, such that the separation blocks separate the first soldering portion and the second soldering portion of the corresponding one of the at least one second signal terminal in the first direction.

In certain embodiments, the first direction is defined as a front-rear direction, an upper surface of the first soldering portion is a first soldering surface configured to be soldered to the first mating portion, an upper surface of the second soldering portion of the corresponding one of the at least one second signal terminal is a second soldering surface configured to be soldered to the second mating portion, and an upper surface of each of the separation blocks is provided to be not higher than the first soldering surface and the second soldering surface.

In certain embodiments, a plurality of pairs of first signal terminals and a plurality of pairs of second signal terminals are provided, the plastic seat comprises a first plastic member and a second plastic member mounted to each other, the first signal terminals are provided in the first plastic member, the conductive terminals are provided in the second plastic member, the first direction is defined as a front-rear direction, the first soldering portion is located behind the second soldering portion of a corresponding one of the second signal terminals, the second plastic member is provided with a plurality of receiving slots, each of the receiving slots corresponds to each pair of the first signal terminals, the receiving slots run backward through the second plastic member, a separation wall is provided at each of a left side and a right side of each of the receiving slots, and portions of the ground terminals extend from the separation walls at the left side and the right side of each of the receiving slots; and the first plastic member comprises a base body and a plurality of protruding portions protrudingly provided relative to the base body, the protruding portions are correspondingly accommodated in the receiving slots, and a portion of each pair of the first signal terminals are mounted in a corresponding one of the protruding portions.

In certain embodiments, each of the receiving slots comprises a first slot and a second slot located behind the first slot, the second slot runs through the second plastic member backward and along the vertical direction, the first slot runs through one side of the second plastic member in the vertical direction, the second plastic member is provided with a separation plate at another side of the first slot in the vertical direction, the separation plate is provided with two openings, the openings run vertically through the separation plate and are in communication with the first slot, the first slot accommodates the first soldering portion and the second soldering portion of the corresponding one of the second signal terminals, the openings allows the first soldering portion and the second soldering portion of the corresponding one of the second signal terminals to expose in a corresponding one of the openings in the vertical direction, and the electronic component is received in the openings.

In certain embodiments, the ground terminals extend to pass beyond the second soldering portion of a corresponding one of the at least one second signal terminal and extend toward the first signal terminal to an adjacent side of the first signal terminal, the connector assembly further comprises at least one electrostatic discharge protection component, and the electrostatic discharge protection component is soldered to a corresponding one of the at least one first signal terminal and one of the ground terminals adjacent to the corresponding one of the at least one first signal terminal.

In certain embodiments, the first direction is defined as a front-rear direction, the plastic seat is provided with a plurality of mounting slots, each of the mounting slots runs through a side of the plastic seat along the vertical direction, a portion of the first signal terminal and a portion of the one of the ground terminals adjacent thereto are exposed by one of the mounting slots, and each of the at least one electrostatic discharge protection component is correspondingly provided in a corresponding one of the mounting slots.

In certain embodiments, a plurality of pairs of first signal terminals and a plurality of pairs of second signal terminals are provided, the plastic seat comprises a plurality of first plastic members and a second plastic member, the first plastic members are assembled on the second plastic member, each pair of the first signal terminals are provided in one of the first plastic member, the conductive terminals are provided in the second plastic member, each of the first plastic members and the second plastic member collectively form a pair of disposing slots, each pair of the disposing slots run through a respective side of a corresponding one of the first plastic members and a respective side of the second plastic member in a vertical direction, the vertical direction is perpendicular to the first direction, the disposing slots correspondingly expose the first soldering portions and the second soldering portions of the second signal terminals, and the electronic components are disposed in the disposing slots.

In certain embodiments, the electronic component is a surface-mount capacitor, and the first signal terminals and the second signal terminals soldered to the electronic component are signal transmitting ends of high frequency signals.

The present invention further provides a connector assembly, which includes: a housing; and a terminal module, provided in the housing; wherein the terminal module comprises: at least one pair of first signal terminals and a plurality of conductive terminals comprising at least one pair of second signal terminals and a plurality of ground terminals, wherein the first signal terminals and the second signal terminals are formed individually, each of the at least one first signal terminal comprises a first body portion and a first soldering portion and a tail portion provided at two opposite ends of the first body portion, each of the conductive terminals comprises a second body portion and a contact portion and a second soldering portion provided at two opposite ends of the second body portion, and each pair of the first signal terminals and a corresponding pair of the second signal terminals are configured to transmit differential signals; a plastic seat, wherein the first signal terminals and the second signal terminals are both mounted in the plastic seat, the first soldering portion of each of the first signal terminals aligns with the second soldering portion of a corresponding one of the second signal terminals along a first direction, and an interval is formed between the first soldering portion and the corresponding second soldering portion; and at least one capacitor, correspondingly provided at one of the interval, wherein the capacitor has a first mating portion and a second mating portion, the first mating portion is soldered to the first soldering portion, and the second mating portion is soldered to the second soldering portion.

In the present invention, the first signal terminal and the second signal terminal are formed individually, and the first soldering portion of the first signal terminal and the second soldering portion of the second signal terminal are provided to be separated to form the interval. That is, there is no need to cut the middle portion of the entire signal terminals with a cutting tool to form a break therebetween, thus facilitating the manufacturing of the terminal module, and the electronic component is provided at the corresponding position of the interval, thus improving the electrical characteristics of the terminal module.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a schematic view of strip connecting of the first signal terminals and the first strip and strip connecting of the conductive terminals and the second strip of a terminal module of a connector assembly according to a first embodiment of the present invention.

FIG. 2 is a schematic view of insert-molding the first plastic member on the first signal terminals and insert-molding the second plastic member on the conductive terminals in FIG. 1.

FIG. 3 is a schematic view of breaking the connections between the first signal terminals and the first strip and removing the first strip and breaking the connections between the second signal terminals and the second strip and removing the portions of the second strip connected to the second signal terminals in FIG. 2.

FIG. 4 is a schematic view of assembling the first plastic member with the first signal terminals to the second plastic member with the conductive terminals in FIG. 3.

FIG. 5 is a schematic view of being ready to mount the electronic components and the electrostatic discharge protection components to the plastic seat in FIG. 4.

FIG. 6 is a partial enlarged view of a position A in FIG. 5.

FIG. 7 is a schematic view of being ready to mount a metal shielding sheet after mounting the electronic component and the electrostatic discharge protection component to the plastic seat and then after breaking the connections between the second strip and the conductive terminals and removing the second strip in FIG. 6.

FIG. 8 is a schematic view of mounting the metal shielding sheet to the plastic seat in FIG. 7.

FIG. 9 is a perspective exploded view of a connector assembly having the terminal module according to the first embodiment of the present invention.

FIG. 10 is a top view of the connector assembly after being assembled in FIG. 9 viewing along the vertical direction.

FIG. 11 is a sectional view of FIG. 10 along the sectional line B-B.

FIG. 12 is a partial enlarged view of a position C in FIG. 11.

FIG. 13 is a top view of the terminal module in FIG. 9, in which only some of the conductive terminals and some of the first signal terminals are shown.

FIG. 14 is a perspective view of the terminal module in FIG. 9 in another angle, in which only the first signal terminals, the first plastic member and the conductive terminals are shown.

FIG. 15 is a perspective view of the terminal module in FIG. 9 in another angle, in which only the first signal terminals and the first plastic member are shown.

FIG. 16 is a perspective view of the terminal module in FIG. 9 in another angle, in which only the conductive terminals and the second plastic member are shown.

FIG. 17 is a partial enlarged view of a position D in FIG. 16.

FIG. 18 is a perspective view of the terminal module in FIG. 9 being 180° inversed, in which only the first plastic member and the second plastic member before assembly are shown.

FIG. 19 is a perspective view of disposing the first signal terminals in FIG. 16 and being 180° inversed.

FIG. 20 is a partial enlarged view of a position E in FIG. 19.

FIG. 21 is a perspective view of the terminal assembly in FIG. 9 in a different angle.

FIG. 22 is a schematic view of strip connecting of the first signal terminals and the first strip and strip connecting of the conductive terminals and the second strip of a terminal module of a connector assembly according to a second embodiment of the present invention.

FIG. 23 is a schematic view of insert-molding the first plastic member on the first signal terminals and insert-molding the second plastic member on the conductive terminals in FIG. 22.

FIG. 24 is a schematic view of breaking the connections between the first signal terminals and the first strip and removing the first strip and breaking the connections between the second signal terminals and the second strip and removing the portions of the second strip connected to the second signal terminals in FIG. 23.

FIG. 25 is a partial enlarged view of a position F in FIG. 24.

FIG. 26 is a schematic view of assembling the first plastic member with the first signal terminals to the second plastic member with the conductive terminals and being ready to mount the electronic components in FIG. 24.

FIG. 27 is a partial enlarged view of a position G in FIG. 26.

FIG. 28 is a schematic view of being ready to mount a metal shielding sheet after mounting the electronic component and the electrostatic discharge protection component to the plastic seat and then after breaking the connections between the second strip and the conductive terminals and removing the second strip in FIG. 24.

FIG. 29 is a schematic view of mounting the metal shielding sheet to the plastic seat in FIG. 28.

FIG. 30 is a perspective exploded view of a connector assembly having the terminal module according to the second embodiment of the present invention.

FIG. 31 is a top view of the connector assembly after being assembled in FIG. 30 viewing along the vertical direction Z.

FIG. 32 is a sectional view of FIG. 31 along the sectional line H-H.

FIG. 33 is a partial enlarged view of a position I in FIG. 32.

FIG. 34 is a perspective view of FIG. 24 in another angle, in which only a pair of the first signal terminals and a corresponding first plastic member are shown.

FIG. 35 is a top view of FIG. 29.

FIG. 36 is a sectional view of FIG. 35 along the sectional line J-J.

FIG. 37 is a perspective view of the terminal assembly in FIG. 30 in a different angle.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated. As used herein, the terms “comprising”, “including”, “carrying”, “having”, “containing”, “involving”, and the like are to be understood to be open-ended, i.e., to mean including but not limited to.

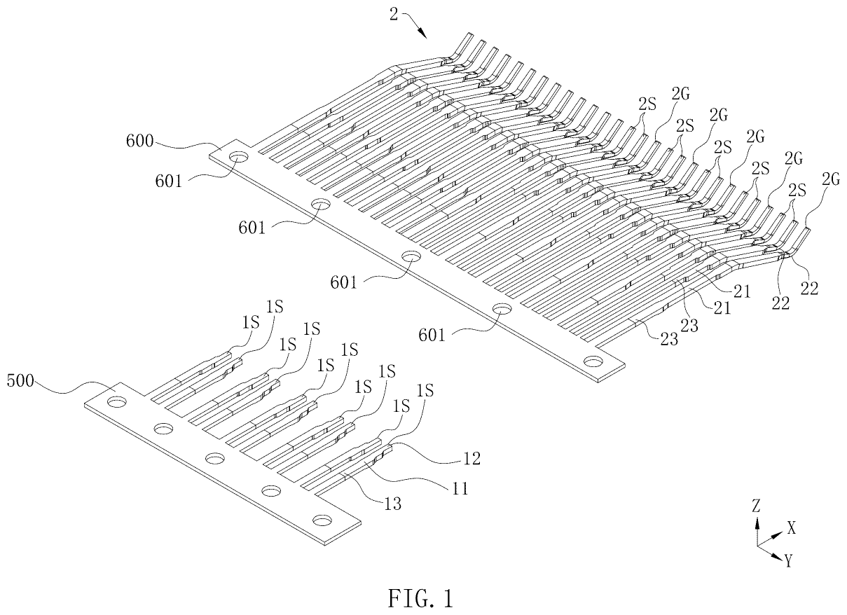

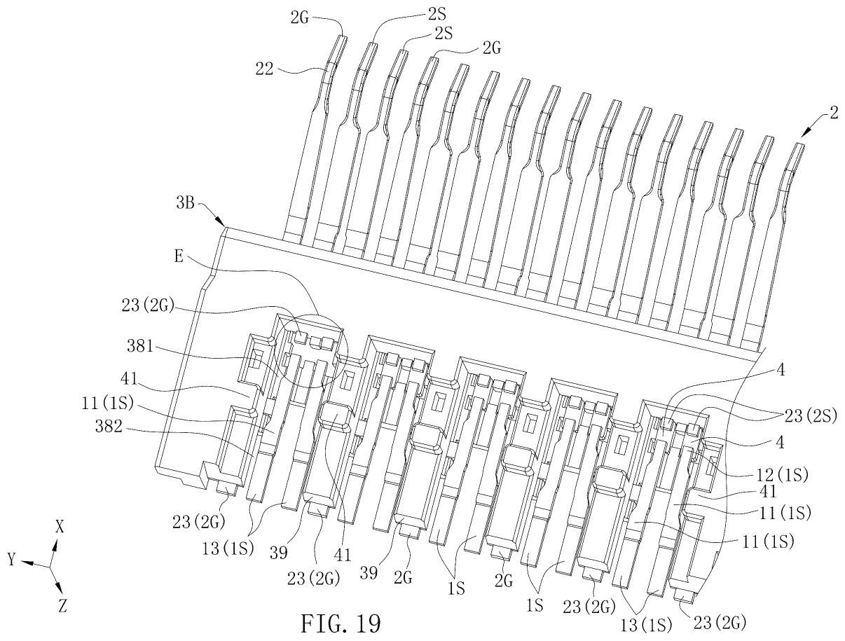

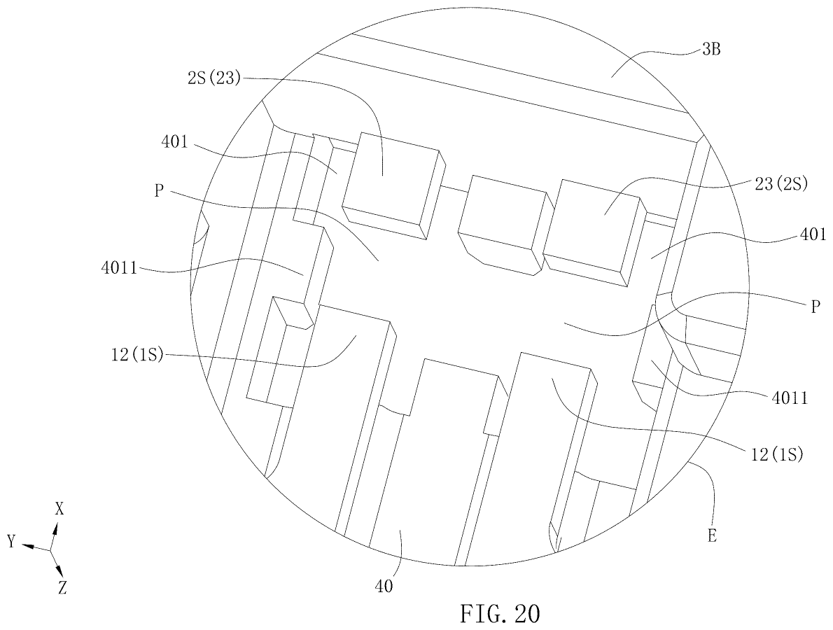

The description will be made as to the embodiments of the present invention in conjunction with the accompanying drawings in FIGS. 1-37. In accordance with the purposes of this invention, as embodied and broadly described herein, this invention, in one aspect, relates to a method of manufacturing a terminal module and a connector assembly.

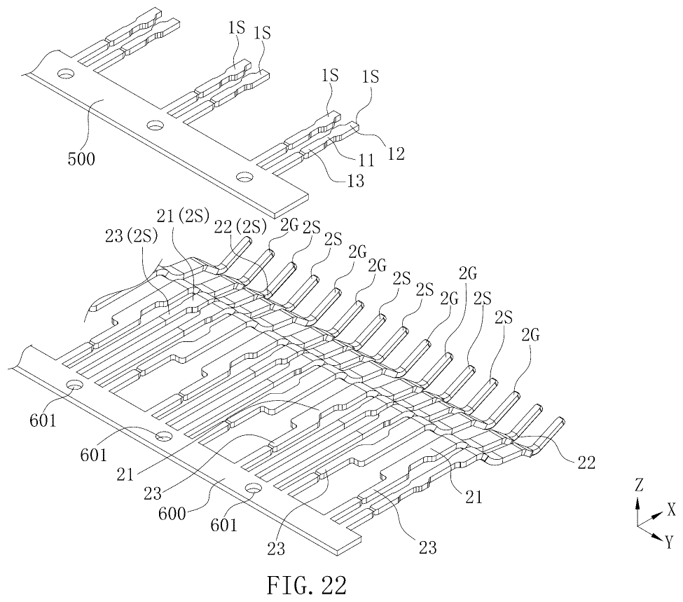

FIG. 1 to FIG. 12 show a terminal module 200 according to a first embodiment of the present invention and a connector assembly having the terminal module 200 according to the first embodiment. FIG. 22 to FIG. 36 show a terminal module 200 according to a second embodiment of the present invention and a connector assembly having the terminal module 200 according to the second embodiment. The first embodiment is described using a GEN-Z cable connector as an example, but is not limited to GEN-Z. The second embodiment is described using a PCI-E cable connector as an example, but is not limited to PCI-E.

In the connector assembly according to the present invention, a first direction, a second direction and a third direction. The first direction, the second direction and the third direction are perpendicular to each other. For convenience of understanding and description, in any of the two aforementioned embodiments, the first direction is defined as a front-rear direction X, the second direction is defined as a vertical direction Z, and the third direction is defined as a left-right direction Y. In other embodiments, the specific orientations of the first direction, the second direction and the third direction may be limited according to the specific usage of the connector assembly.

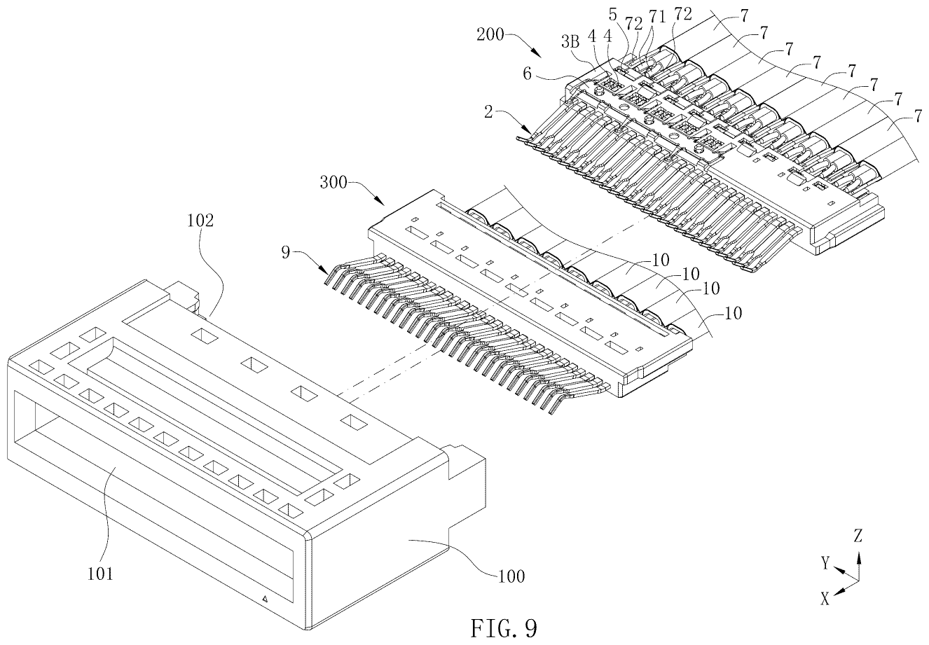

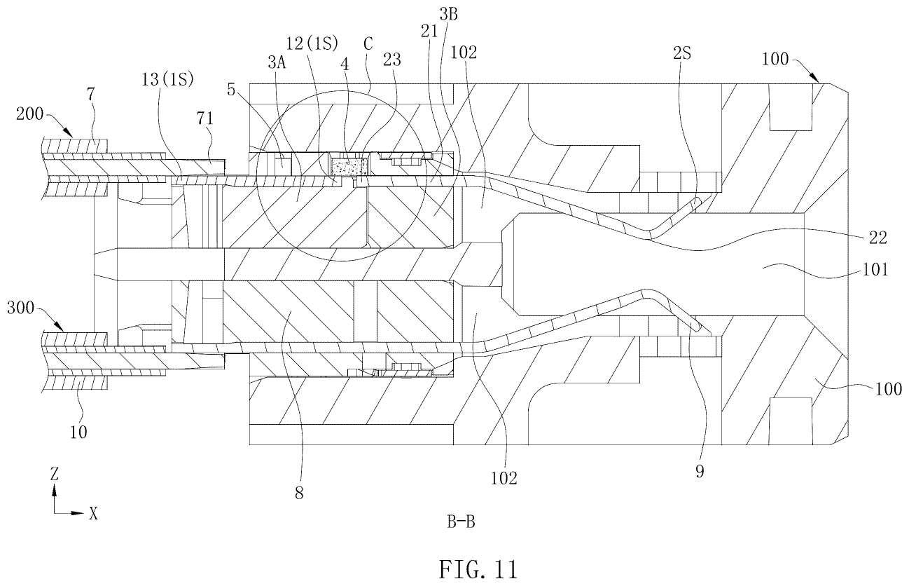

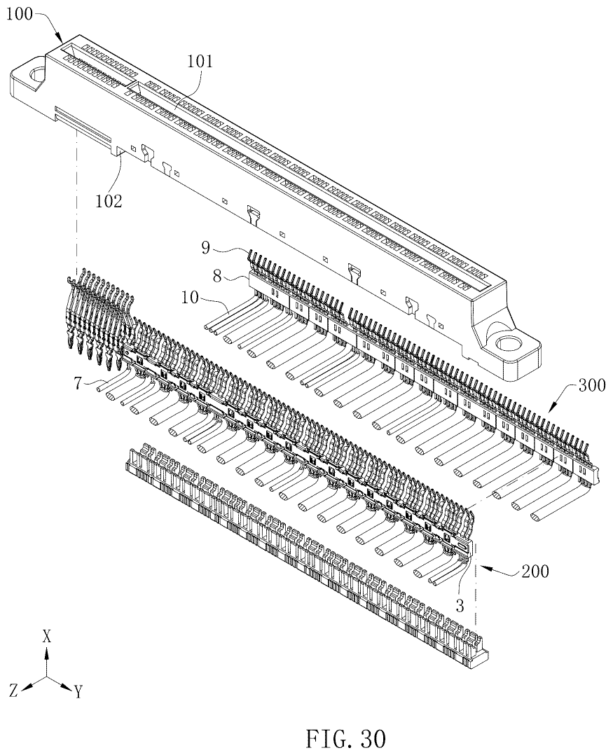

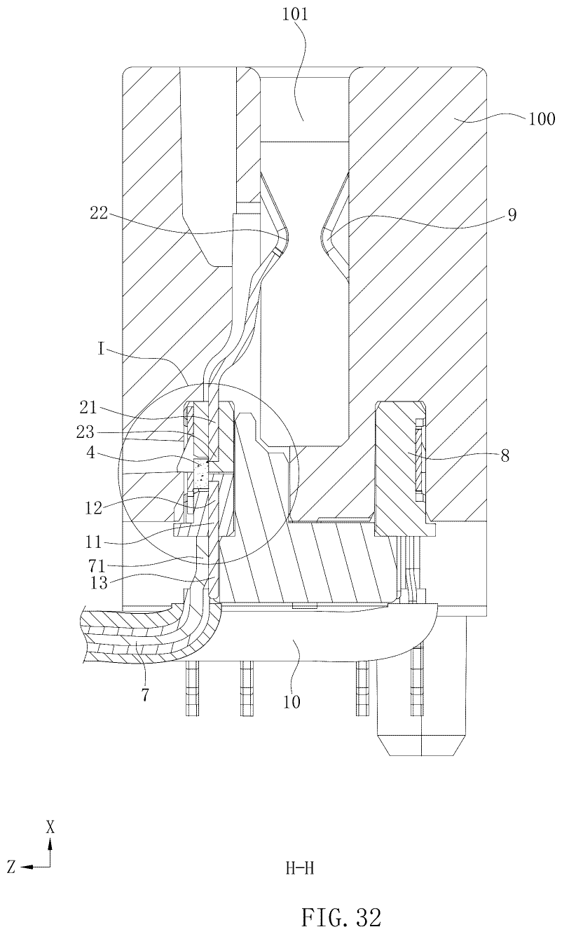

As shown in FIG. 9, FIG. 11, FIG. 30 and FIG. 32, in any of the aforementioned embodiments, the connector assembly includes a housing 100, a terminal module 200 and a terminal assembly 300. The terminal module 200 and the terminal assembly 300 are provided opposite to each other along the vertical direction Z, and both are provided and received in the housing 100. In any of the two aforementioned embodiments, the description is made using an example in which the terminal module 200 is located above the terminal assembly 300.

As shown in FIG. 9, FIG. 11, FIG. 30 and FIG. 32, in any of the two aforementioned embodiments, the housing 100 is made of an insulating material and includes a mating slot 101 and two assembling slots 102 provided to be opposite along the front-rear direction X. The mating slot 101 is concavely formed backward from a front end surface of the housing 100 for a mating component (not shown) to insert therein. The assembling slots 102 are concavely formed forward from a rear end surface of the housing. The terminal module 200 and the terminal assembly 300 are one-to-one correspondingly assembled to the two assembling slots 102 to be mounted to the housing 100. Specifically, the mating connector in the second embodiment is an electronic card. In other embodiments, only one assembling slot 100 is provided, and the terminal module 200 and the terminal assembly 300 may be assembled to each other and collectively assembled in the same assembling slot 100.

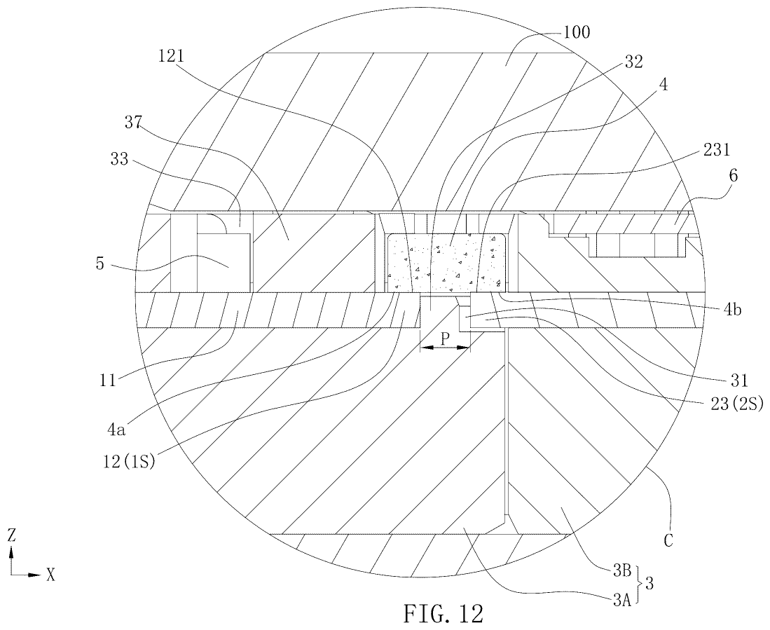

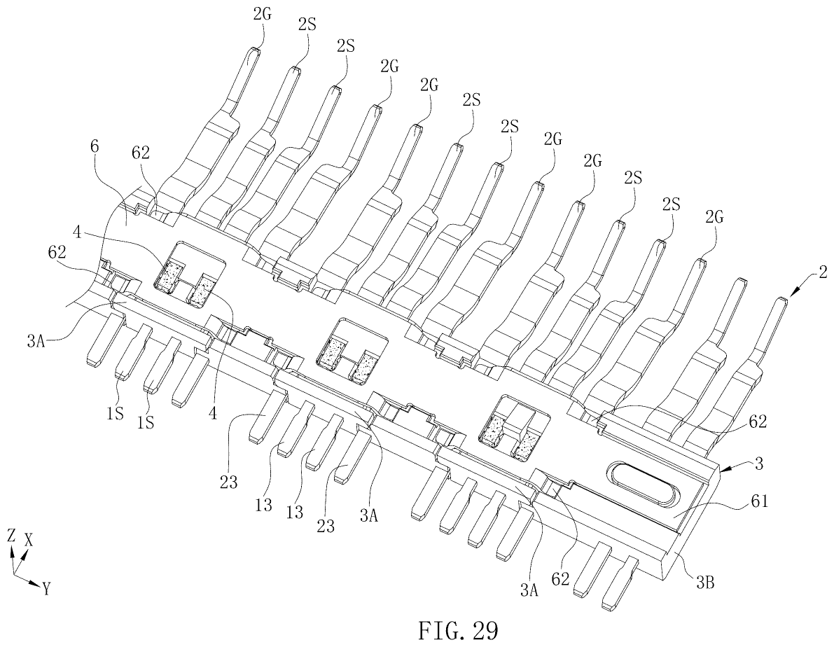

As shown in FIG. 9, FIG. 12, FIG. 29 and FIG. 30, in any of the two aforementioned embodiments, the terminal module 200 includes a plurality of pairs of first signal terminals 1S, a plurality of conductive terminals 2, a plastic seat 3, a plurality of electronic components 4, a metal shielding sheet 6, and a first row of cables 7. The pairs of the first signal terminals 1S and the conductive terminals 2 are all mounted in the plastic seat 3. In the first embodiment, the terminal module 200 further includes a plurality of electrostatic discharge protection components 5. It should be understood that, in the second embodiment, the electrostatic discharge protection components 5 may also be provided. The metal shielding sheet 6 covers the periphery of the plastic seat 3 and is located at a side of the plastic seat 3 away from the terminal assembly 300. Specifically, the metal shielding sheet 6 covers the upper side of the plastic seat 3, and the first row of cables 7 are soldered to a rear end of the terminal module 200. It should be understood that the pairs of the first signal terminals 1S are used to transmit differential signals. In other embodiments, the first signal terminals 1S may also be used individually to transmit single-ended signals.

As shown in FIG. 1 and FIG. 22, in any of the two aforementioned embodiments, the pairs of the first signal terminals 1S are formed by stamping a first metal plate. Each first signal terminal 1S includes a first body portion 11 as well as a first soldering portion 12 and a tail portion 13 respectively provided at two opposite ends of the first body portion 11. Specifically, the first soldering portion 12 is located in front of the first body portion 11, and the tail portion 13 is located behind the first body portion 11.

As shown in FIG. 1 and FIG. 22, in any of the two aforementioned embodiments, the conductive terminals 2 are formed by stamping a second metal plate, and the conductive terminals 2 and the first signal terminals 1S are formed on different metal plates. The conductive terminals 2 are provided side-by-side in the left-right direction Y, and include a plurality of pairs of second signal terminals 2S and a plurality of ground terminals 2G. One of the ground terminals 2G is provided at each of a left side and a right side of each pair of the second signal terminals 2S. Each conductive terminal 2 includes a second body portion 21 as well as a contact portion 22 and a second soldering portion 23 respectively provided at two opposite ends of the second body portion 21. Specifically, the contact portion 22 is located in front of the second body portion 21, and the second soldering portion 23 is located behind the second body portion 21. It should be understood that the pairs of the second signal terminals 2S are used to transmit differential signals. In other embodiments, the second signal terminals 2S may also be used individually to transmit single-ended signals.

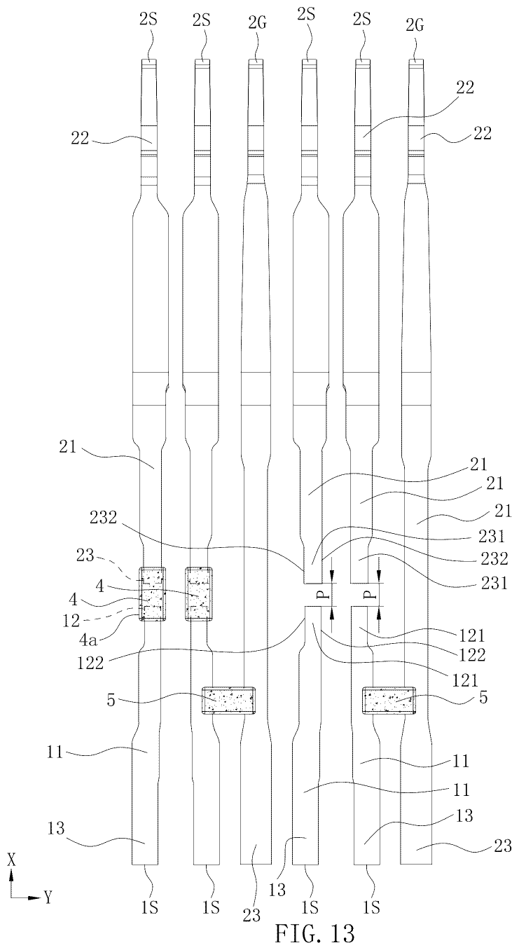

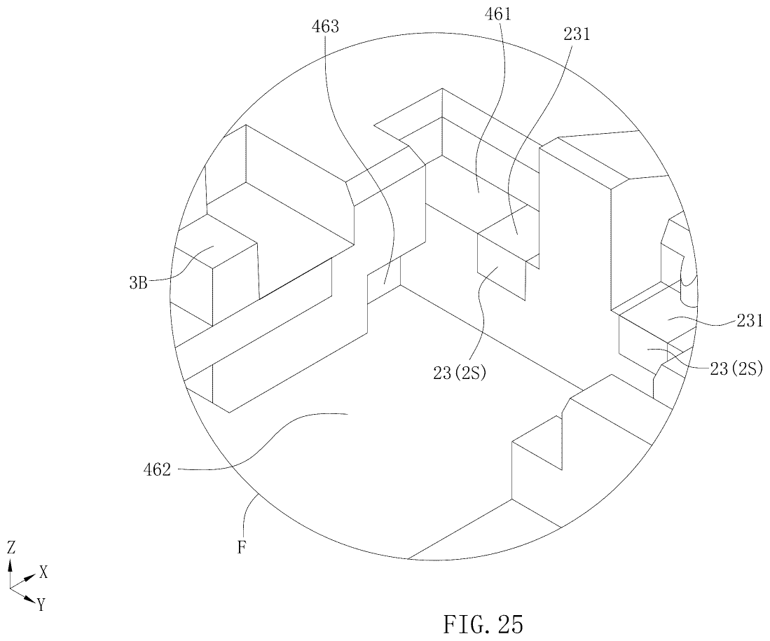

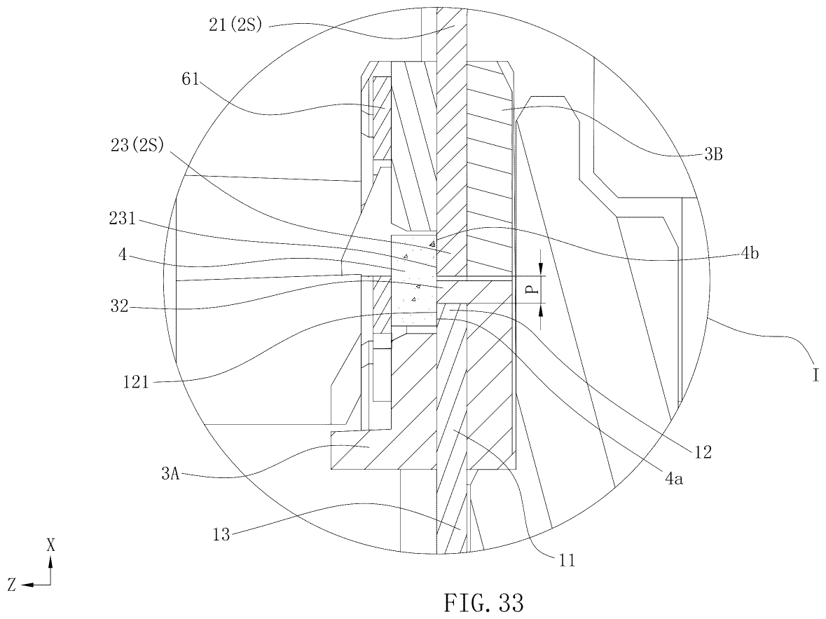

As shown in FIG. 13, FIG. 25 and FIG. 33, in any of the two aforementioned embodiments, the pairs of the second signal terminals 2S are one-to-one aligned with the pairs of the first signal terminals 1S in the front-rear direction X. The second soldering portion 23 of each second signal terminal 2S is located in front of the first soldering portion 12 of a corresponding first signal terminal 1S, and an interval P is formed between the second soldering portion 23 of each second signal terminal 2S and the first soldering portion 12 of the corresponding first signal terminal 1S in the front-rear direction X. In other embodiments, it is possible to provide only one pair of the first signal terminals 1S and one pair of the second signal terminals 2S.

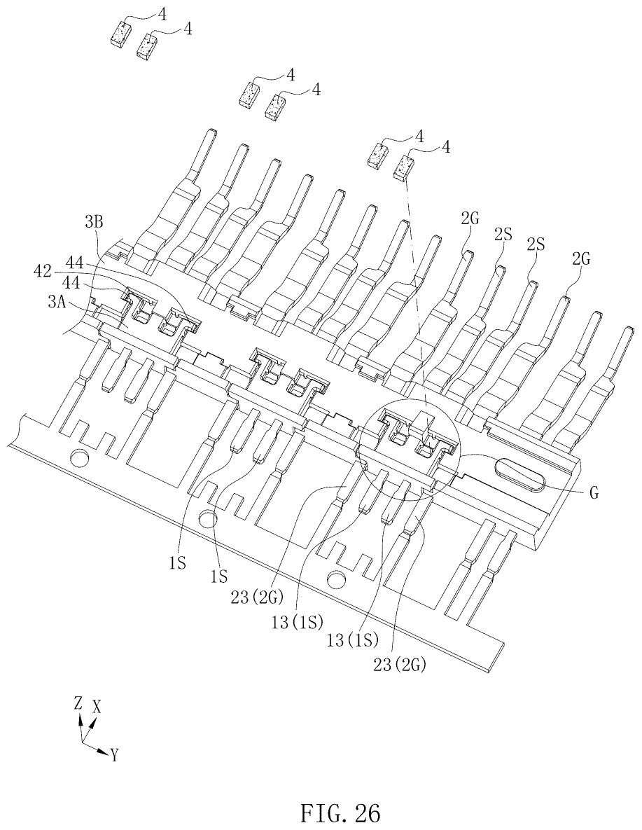

As shown in FIG. 13 and FIG. 26, in any of the two aforementioned embodiments, the second soldering portion 23 of each ground terminal 2G extends backward beyond the corresponding second signal terminal 2S and extends to one side of the corresponding first signal terminal 1S. Specifically, the second soldering portion 23 of each ground terminal 2G and the tail portion 13 of the first signal terminal 1S are provided side-by-side in the left-right direction Y.

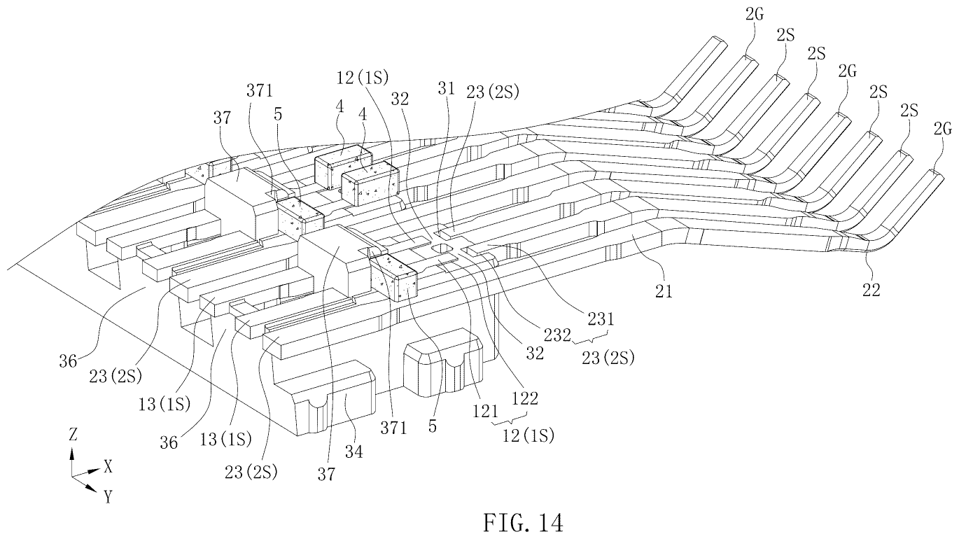

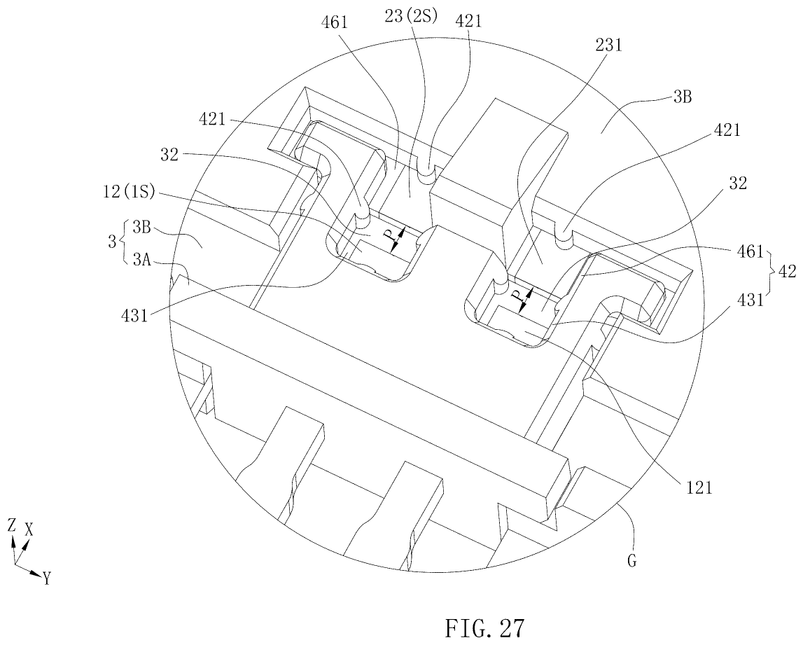

As shown in FIG. 13, FIG. 14, FIG. 27 and FIG. 33, in any of the two aforementioned embodiments, a first soldering surface 121 is formed on a surface of the first soldering portion 12 of the first signal terminal 1S at one side in the vertical direction Z. Specifically, the first soldering surface 121 is provided on an upper surface of the first soldering portion 12, and a width of the first soldering surface 121 in the left-right direction Y is less than a width of the first body portion 11 of the first signal terminal 1S in the left-right direction Y. A second soldering surface 231 is formed on a surface of the second soldering portion 23 of the second signal terminal 2S at one side in the vertical direction Z. Specifically, the second soldering surface 231 is provided on an upper surface of the second soldering portion 23, and a width of the second soldering surface 231 in the left-right direction Y is less than a width of the second body portion 21 of the second signal terminal 2S in the left-right direction Y. The widths of the first soldering surface 121 and the second soldering surface 231 are equal in the left-right direction Y, and the first soldering surface 121 and the second soldering surface 231 are provided at an equal height in the vertical direction Z.

As shown in FIG. 13 and FIG. 14, in the first embodiment, two third soldering surfaces 122 are formed on the surface of the first soldering portion 12 of the first signal terminal 1S in the left-right direction Y. That is, for the same first soldering portion 12, the two third soldering surfaces 122 are located at a left side and a right side of the first soldering surface 121. Two fourth soldering surfaces 232 are formed on the surface of the second soldering portion 23 of the second signal terminal 2S in the left-right direction Y. That is, for the same second soldering portion 23, the two fourth soldering surfaces 232 are located at a left side and a right side of the second soldering surface 231. The third soldering surfaces 122 and the fourth soldering surfaces 232 are all exposed on a surface of the plastic seat 3. Specifically, when spray-coating the solder, for the same first signal terminal 1S, the first soldering surface 121 and the third soldering surfaces 122 of the first soldering portion 12 are all connected to the solder, and for the same second signal terminal 2S, the second soldering surface 231 and the fourth soldering surfaces 232 of the second soldering portion 23 may all be connected to the solder.

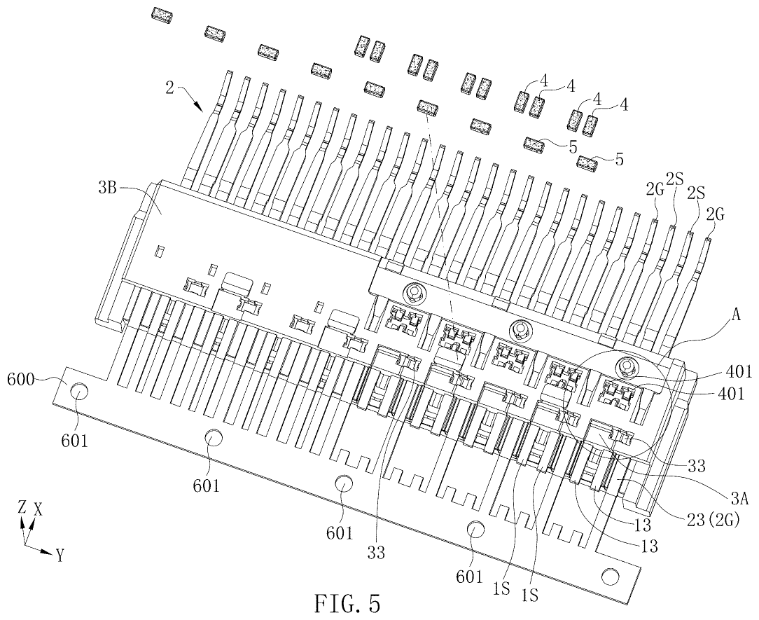

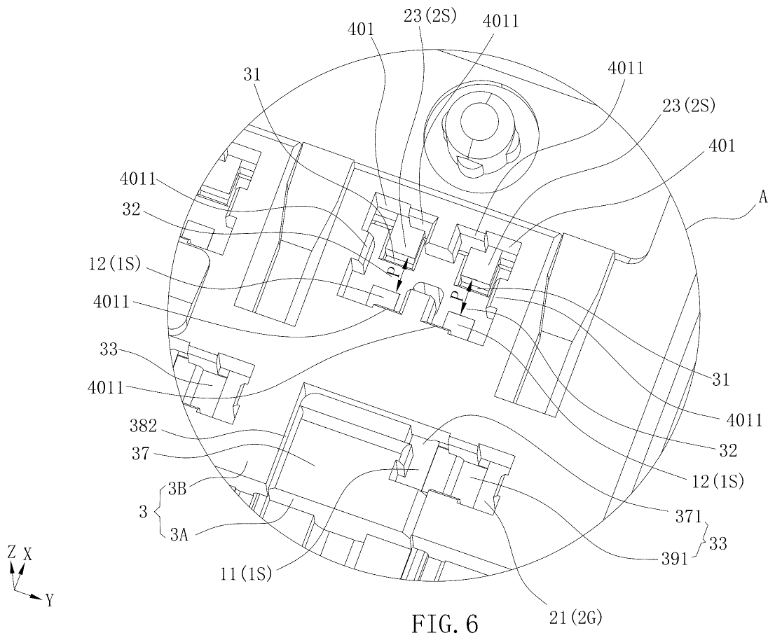

As shown in FIG. 5 and FIG. 6, in the first embodiment, the plastic seat 3 includes a first plastic member 3A, a second plastic member 3B, a plurality of positioning recesses 31, a plurality of separation blocks 32 and a plurality of mounting slots 33. The pairs of the first signal terminals 1S are mounted in the first plastic member 3A, and the conductive terminals 2 are mounted in the second plastic member 3B. Specifically, the first signal terminals 1S are provided in the first plastic member 3A by insert-molding, and the conductive terminals 2 are provided in the second plastic member 3B by insert-molding. In other embodiments, the first signal terminals 1S may be inserted into the first plastic member 3A, the conductive terminals 2 may be inserted into the second plastic member 3B, and the specific configuration may be determined according to the actual situation. It should be understood that, in other embodiments, the plastic seat 3 may be an integral structure. Thus, the conductive terminals 2 and the first signal terminals 1S are mounted in the plastic seat 3 in a sequential manner. That is, the conductive terminals 2 may be firstly provided in the plastic seat 3 by insert-molding, and then the first signal terminals 1S are inserted into the plastic seat 3, without being specifically limited herein.

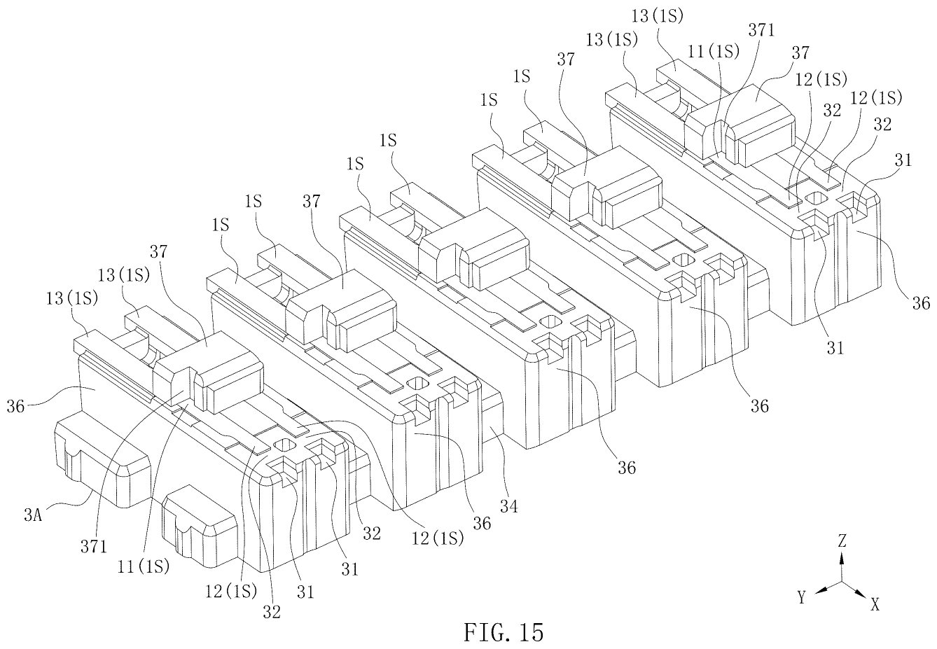

As shown in FIG. 14 and FIG. 15, in the first embodiment, the positioning recesses 31 are formed in the first plastic member 3A. The positioning recesses 31 run forward through the first plastic member 3A and run through a side of the first plastic member 3A in the vertical direction Z. Specifically, the positioning recesses 31 run upward through the first plastic member 3A. The second soldering portions 23 of the second signal terminals 2S protrude backward out of the second plastic member 3B and one-to-one correspondingly protrude into the positioning recesses 31, thus facilitating precise positioning of the first soldering portion 12 and the second soldering portion 23 of the second signal terminal 2S. In addition, the second soldering surface 231 is exposed upward outside the corresponding positioning recess 31 in the vertical direction Z. In other embodiments, the positioning recesses 31 may also be formed in the second plastic member 3B, such that the first soldering portions 12 of the first signal terminals 1S protrude forward out of the first plastic member 3A and one-to-one correspondingly protrude into the positioning recesses 31, thus facilitating precise positioning. In addition, the first soldering surface 121 is exposed upward outside the corresponding positioning recess 31 in the vertical direction Z

As shown in FIG. 12 and FIG. 14, in the first embodiment, the separation blocks 32 are provided on the first plastic member 3A, and the separation blocks 32 are provided to one-to-one correspond to the intervals P. An upper surface of each separation block 32 is not higher than the first soldering surface 121 and the second soldering surface 231. Specifically, the first soldering surface 121, the second soldering surface 231, the third soldering surfaces 122 and the fourth soldering surfaces 232 are all higher than the upper surface of the corresponding separation block 32 in the vertical direction Z, thus allowing the third soldering surfaces 122 and the fourth soldering surfaces 232 to be connected to the solder. Each separation block 32 protrudes into the corresponding interval P, such that the separation block 32 separates the first soldering portion 12 from the second soldering portion 23 of the corresponding second signal terminal 2S in the front-rear direction X, thus ensuring that each interval P is within a specified dimension range, and preventing the first soldering portion 12 and the corresponding second soldering portion 23 from short-circuiting. In other embodiments, each separation block 32 may also be provided on the second plastic member 3B. Alternatively, each separation block 32 may be provided on both the first plastic member 3A and the second plastic member 3B.

As shown in FIG. 5 and FIG. 6, in the first embodiment, each mounting slot 33 has a portion formed in the first plastic member 3A and another portion formed in the second plastic member 3B. Each mounting slot 33 allows a side of the first body portion 11 of one of a pair of the first signal terminals 1S in the vertical direction Z to be exposed, and allows a side of the second body portion 21 of a grounding terminal 2G adjacent to the one of the first signal terminals 1S in the vertical direction Z to be exposed. Specifically, the first body portion 11 of the first signal terminal 1S and the second body portion 21 of the adjacent grounding terminal 2G are both exposed upward in the corresponding mounting slot 33.

As shown in FIG. 15, in the first embodiment, the first plastic member 3A includes a base body 34, a plurality of protruding portions 36 and a plurality of stopping blocks 37. The protruding portions 36 are protrudingly provided on the base body 34, and the stopping blocks 37 are protrudingly provided one-to-one correspondingly on the protruding portions 36. Each protruding portion 36 has a portion formed by protruding upward from the base body 34 in the vertical direction Z and another portion formed by protruding forward from the base body 34. Each stopping block 37 is formed by protruding from the protruding portion 36 in the vertical direction Z toward a side away from the base body 34. Specifically, each protruding portion 36 has a portion formed by protruding upward from the base body 34 and another portion formed by protruding forward from the base body 34, and the corresponding stopping block 37 is formed by protruding upward from the protruding portion 36.

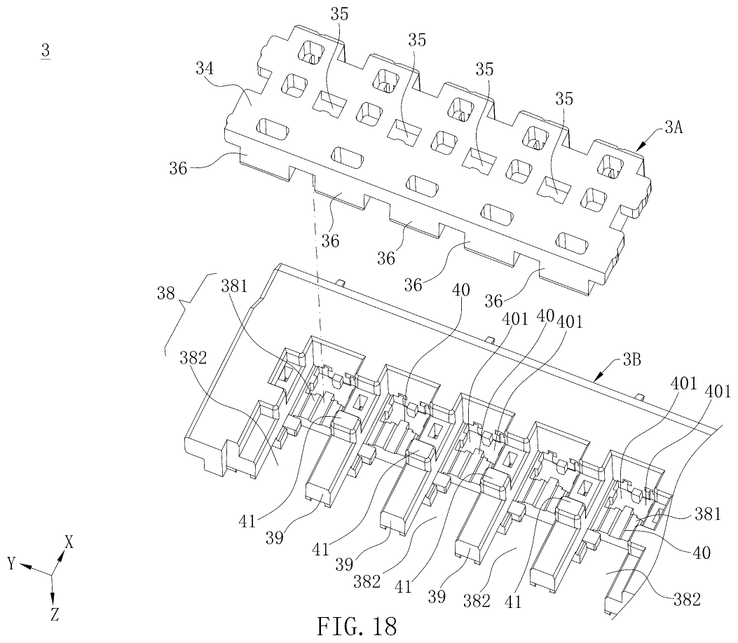

As shown in FIG. 15 and FIG. 18, in the first embodiment, the base body 34 includes a plurality of positioning slots 35, and the positioning slots 35 run through the base body 34 along the vertical direction Z. Specifically, a positioning slot 35 is provided between each two protruding portions 36.

As shown in FIG. 12 and FIG. 15, in the first embodiment, each protruding portion 36 is mounted with a pair of the first signal terminals 1S. Each stopping block 37 covers the first body portions 11 of the corresponding pair of the first signal terminals 1S, and the first soldering portions 12 and the tail portions 13 of the corresponding pair of the first signal terminals 1S are exposed out of the corresponding protruding portion 36 in the front-rear direction X. Each stopping block 37 has a first notch 371, and the first notch 371 allows a side of one of the first body portions 11 of the corresponding pair of the first signal terminals 1S in the vertical direction Z to be exposed. Specifically, the first body portion 11 is exposed upward in the corresponding first notch 371.

As shown in FIG. 14 and FIG. 15, in the first embodiment, specifically, the positioning recesses 31 and the separation blocks 32 are all provided on the protruding portions 36, and each protruding portion 36 is provided with two positioning recesses 31 and two separation blocks 32 to correspond to the second soldering portions 23 of a corresponding pair of the second signal terminals 2S. Each separation block 32 is located behind a corresponding positioning recess 31 in the front-rear direction X.

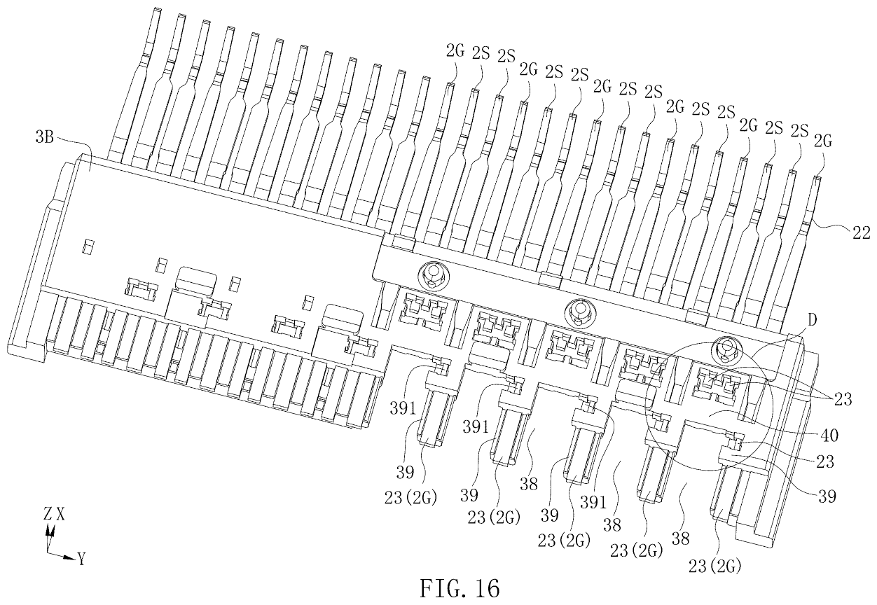

As shown in FIG. 16 to FIG. 18, in the first embodiment, the second plastic member 3B is provided with a plurality of receiving slots 38, a plurality of separation walls 39, a plurality of separation plates 40, and a plurality of positioning posts 41. Each receiving slot 38 is located between two adjacent separation walls 39 in the left-right direction Y and runs backward through the second plastic member 3B. Each receiving slot 38 is correspondingly arranged at a rear end of a pair of the second signal terminals 2S. The separation plates 40 and the receiving slots 38 are one-to-one correspondingly provided, and each separation plate 40 is located on a side of the corresponding receiving slot 38 in the vertical direction Z. Each positioning post 41 is provided at a side of one of the separation walls 39 away from the corresponding separation plate 40 in the vertical direction Z. Specifically, each separation plate 40 is located above the corresponding receiving slot 38, and each positioning post 41 is formed by protruding downward from the corresponding separation wall 39. Alternatively, it is also possible that some of the separation walls 39 are protrudingly provided with the positioning posts 41.

As shown in FIG. 5 and FIG. 18, in the first embodiment, the first plastic member 3A is assembled to the second plastic member 3B along the vertical direction Z, and the first plastic member 3A does not pass beyond the second plastic member 3B in the front-rear direction X. Specifically, the positioning posts 41 and the positioning slots 35 are engaged and match with each other along the vertical direction Z, thereby fixedly connecting the first plastic member 3A and the second plastic member 3B, and each receiving slot 38 is used to accommodate a corresponding one of the protruding portions 36.

As shown in FIG. 18 to FIG. 20, in the first embodiment, each receiving slot 38 includes a first slot 381 and a second slot 382 located behind the first slot 381 in the front-rear direction X. The first slot 381 and the second slot 382 are provided to be in communication in the front-rear direction. The first slot 381 runs through a side of the second plastic member 3B away from the corresponding separation plate 40 along the vertical direction Z. The second slot 382 runs backward through the second plastic member 3B in the front-rear direction X and runs through the second plastic member 3B in the vertical direction Z. Specifically, the first slot 381 runs downward through the second plastic member 3B, and the second slot 382 runs upward through the second plastic member 3B. The first soldering portions 12 of each pair of the first signal terminals 1S and the second soldering portions 23 of the corresponding pair of the second signal terminals 2S are accommodated in a corresponding one of the first slots 381. The tail portions 13 of each pair of the first signal terminals 1S are accommodated in a corresponding one of the second slots 382 and are exposed to the corresponding second slot 382 in the vertical direction Z. Specifically, the tail portions 13 of each pair of the first signal terminals 1S are exposed upward to the corresponding second slot 382.

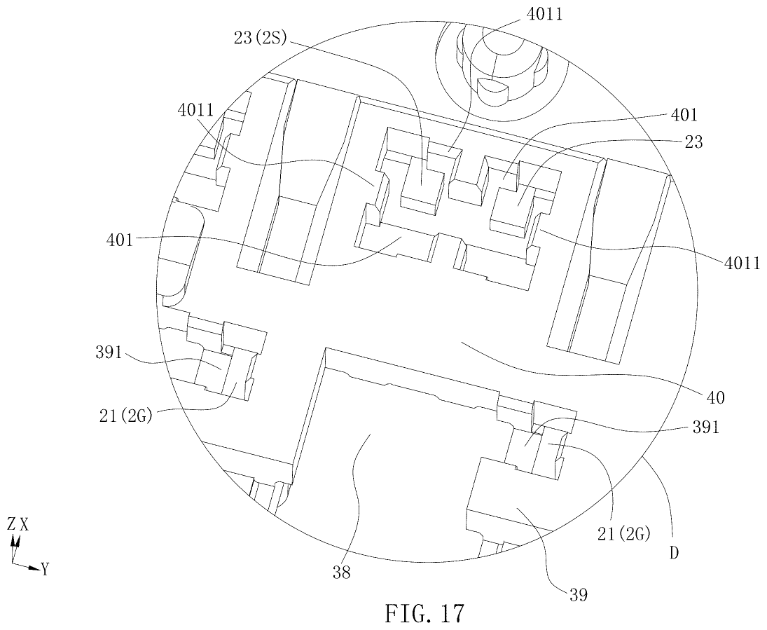

As shown in FIG. 6, FIG. 16 and FIG. 17, in the first embodiment, a portion of each grounding terminal 2G correspondingly extends to a corresponding one of the separation walls 39. Each separation wall 39 is provided with a second notch 391. Each second notch 391 runs through the corresponding separation wall 39 toward a side away from the corresponding positioning post 41 along the vertical direction Z, and is in communication with one of the second slots 382 in the left-right direction Y. For the same separation wall 39, each second notch 391 allows a side the second body portion 21 of a corresponding grounding terminal 2G away from the corresponding positioning post 41 in the vertical direction to be exposed. Specifically, the second notch 391 runs upward through the corresponding separation wall 39, and the second body portion 21 is exposed upward to the corresponding second notch 391. The stopping blocks 37 are one-to-one correspondingly received in the second slots 382, such that each first notch 371 and a corresponding second notch 391 are mated in the left-right direction Y, thus forming one of the mounting slots 33.

As shown in FIG. 17 and FIG. 18, in the first embodiment, each separation plate 40 is formed with two openings 401, and the openings 401 are located in front of the second notches 391 in the front-rear direction X. The openings 401 run through the separation plate 40 along the vertical direction Z and are in communication with the corresponding first slots 381. Each opening 401 is provided to correspond to an interval P in the vertical direction Z.

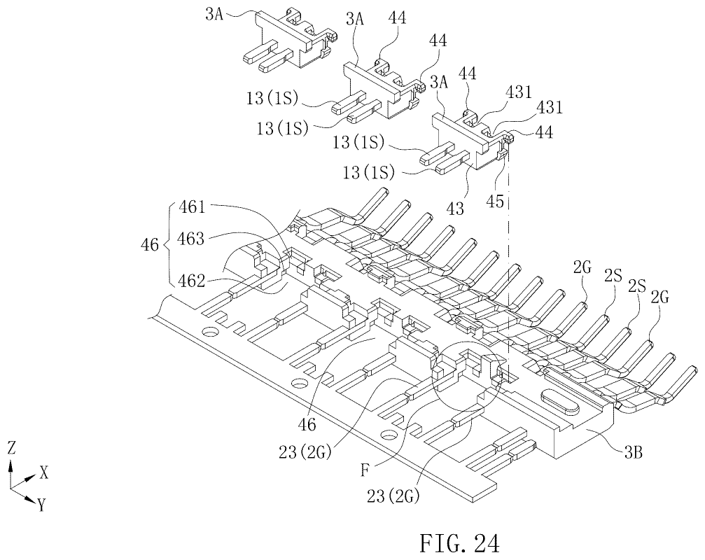

As shown in FIG. 24 and FIG. 27, in the second embodiment, the plastic seat 3 includes a plurality of first plastic members 3A, a second plastic member 3B, a plurality of separation blocks 32, and a plurality of disposing slots 42. The first plastic members 3A are all assembled to the second plastic member 3B along the vertical direction Z. Each first plastic member 3A is mounted with only one pair of the first signal terminals 1S. The second plastic member 3B is mounted with the conductive terminals 2. Each disposing slot 42 has one portion formed in the corresponding first plastic member 3A and another portion formed in the second plastic member 3B. The disposing slots 42 run through respective sides of the corresponding first plastic member 3A and the second plastic member 3B along the vertical direction Z. Specifically, each pair of the first signal terminals 1S is provided in a corresponding first plastic member 3A by insert-molding, and the conductive terminals 2 are provided in the second plastic member 3B by insert-molding. The disposing slots 42 run upward through the first plastic members 3A and the second plastic member 3B.

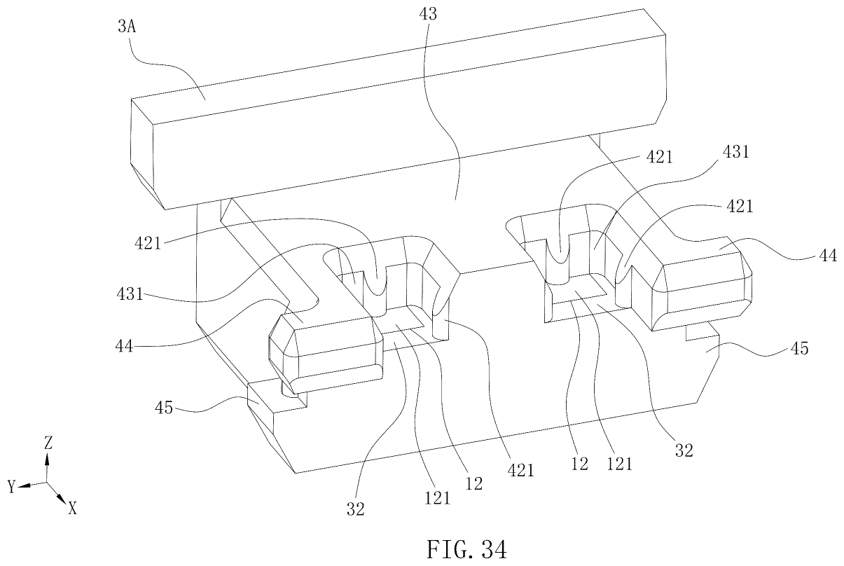

As shown in FIG. 27, FIG. 33 and FIG. 34, in the second embodiment, the separation blocks 32 are provided on the first plastic members 3A, and the separation blocks 32 are provided to one-to-one correspond to the intervals P. Further, an upper surface of each separation block 32 is not higher than the corresponding first soldering surface 121 and the second soldering surface 231. Each separation block 32 protrudes into the corresponding interval P, such that the separation block 32 separates the first soldering portion 12 and the second soldering portion 23 of the corresponding second signal terminal 2S in the front-rear direction X, thereby allowing that the interval P formed between the first soldering portion 12 and the second soldering portion 23 of the corresponding second signal terminal 2S is within a specified dimension range. In other embodiments, the separation blocks 32 may be provided on the second plastic member 3B.

As shown in FIG. 27 and FIG. 34, in the second embodiment, each first plastic member 3A includes a main body 43, two first position limiting portions 44 and two second position limiting portions 45. The two first position limiting portions 44 protrude outward from a left side and a right side of the corresponding main body 43 in the left-right direction Y. The two second position limiting portions 45 protrude outward from the left side and the right side of the corresponding main body 43 in the left-right direction Y. The two first position limiting portions 44 are one-to-one correspondingly located above the two second position limiting portions 45, and each first position limiting portion 44 is located in front of the second position limiting portion 45 at the corresponding side.

As shown in FIG. 27 and FIG. 34, in the second embodiment, a front end of each main body 43 is provided with two first recesses 431. The two first recesses 431 run forward through the corresponding first plastic member 3A in the front-rear direction X and run through a side of the corresponding first plastic member 3A in the vertical direction Z. Each first recess 431 allows a side of the first soldering portion 12 of a corresponding first signal terminal 1S in the vertical direction Z to be exposed. Specifically, the first recesses 431 run upward through the corresponding first plastic member 3A, and the first soldering portion 12 is exposed upward to the corresponding first recess 431.

As shown in FIG. 24 and FIG. 25, in the second embodiment, the second plastic member 3B is provided with a plurality of storage slots 46. Each storage slot 46 includes two second recesses 461, a through slot 462 and two position limiting slots 463. The two second recesses 461 are located in front of the through slot 462 in the front-rear direction X, and the two position limiting slots 463 are respectively located at two opposite sides of the corresponding through slot 462 in the left-right direction Y. Each second recess 461 runs through the second plastic member 3B along a side of the vertical direction Z, and the position limiting slots 463 run through the second plastic member 3B along the other side of the vertical direction Z. The through slot 462 runs through the second plastic member 3B along the vertical direction Z and extends backward through the second plastic member 3B along the front-rear direction X. The second soldering portions 23 of each pair of the second signal terminals 2S are exposed to the two second recesses 461 in the same storage slot 46, and in the same storage slot 46, the second recesses 461 are in backward communication with the through slot 462, and the position limiting slots 463 are in communication with the through slot 462 in the left-right direction Y. Specifically, the second recesses 461 run upward through the second plastic member 3B, and the position limiting slots 463 run downward through the second plastic member 3B.

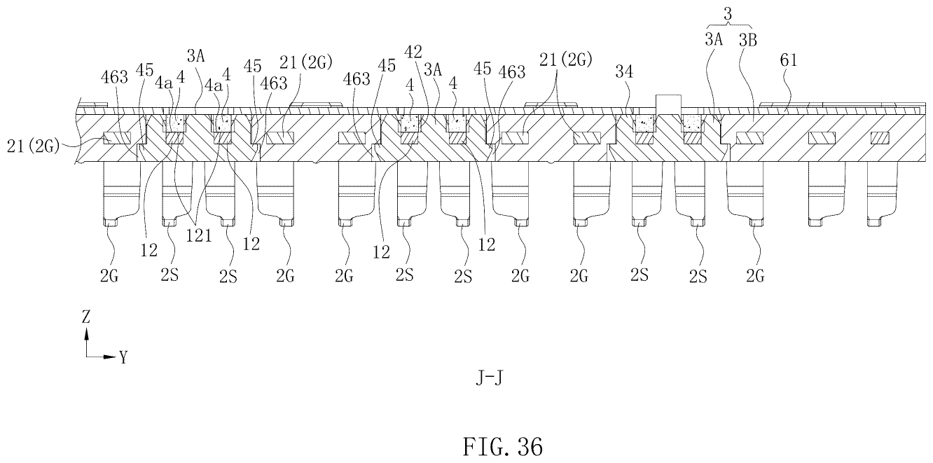

As shown in FIG. 24, FIG. 27 and FIG. 36, in the second embodiment, the storage slots 46 one-to-one correspondingly receive the first plastic members 3A. Specifically, each main body 43 is one-to-one correspondingly accommodated in a corresponding through slot 462 in the vertical direction Z, and the two first position limiting portions 44 of each first plastic member 3A correspondingly protrude into the corresponding two second recesses 461 of one of the storage slots 46 to limit the corresponding first plastic member 3A in the front-rear direction X. The two second position limiting portions 45 of each first plastic member 3A correspondingly protrude into the two position limiting slots 463 of one of the storage slots 46 to limit the corresponding first plastic member 3A in the vertical direction Z. A portion of each second recess 461 is mated with one of the first recesses 431 in the front-rear direction X to form a disposing slot 42.

As shown in FIG. 5, FIG. 12, FIG. 26 and FIG. 33, in any of the two aforementioned embodiments, the electronic components 4 are provided to one-to-one correspond to the intervals P. Each electronic component 4 includes a first mating portion 4a and a second mating portion 4b. In each electronic component 4, the first mating portion 4a is soldered to the first soldering surface 121 of a corresponding one of the first signal terminals 1S by a solder, and the second mating portion 4b is soldered to the second soldering surface 231 of a corresponding one of the second signal terminals 2S by a solder, thereby electrically connecting the corresponding one of the first signal terminals 1S and the corresponding one of the second signal terminals 2S, and further providing the signal filtering and DC blocking functions. Specifically, each electronic component 4 is a surface-mount capacitor.

As shown in FIG. 12, FIG. 13 and FIG. 14, in the first embodiment, in each electronic component 4, the first mating portion 4a is soldered to both the first soldering surface 121 and the third soldering surfaces 122 of the corresponding one of the first signal terminals 1S by solders, and the second mating portion 4b is soldered to both the second soldering surface 231 and the fourth soldering surfaces 232 of the corresponding one of the second signal terminals 2S by solders. Specifically, a width of the first mating portion 4a in the left-right direction Y is greater than a width of the first soldering surface 121 in the left-right direction Y, and the first mating portion 4a protrudes beyond two sides of the first soldering surface 121 in the left-right direction. Similarly, a width of the second mating portion 4b in the left-right direction Y is greater than a width of the second soldering surface 231 in the left-right direction Y, and the second mating portion 4b protrudes beyond two sides of the second soldering surface 231 in the left-right direction Y. Thus, the soldering area between the first soldering portion 12 and the first mating portion 4a is increased by providing the third soldering surfaces 122, and the soldering area between the second soldering portion 23 of the second signal terminal 2S and the second mating portion 4b is increased by providing the fourth soldering surfaces 232.

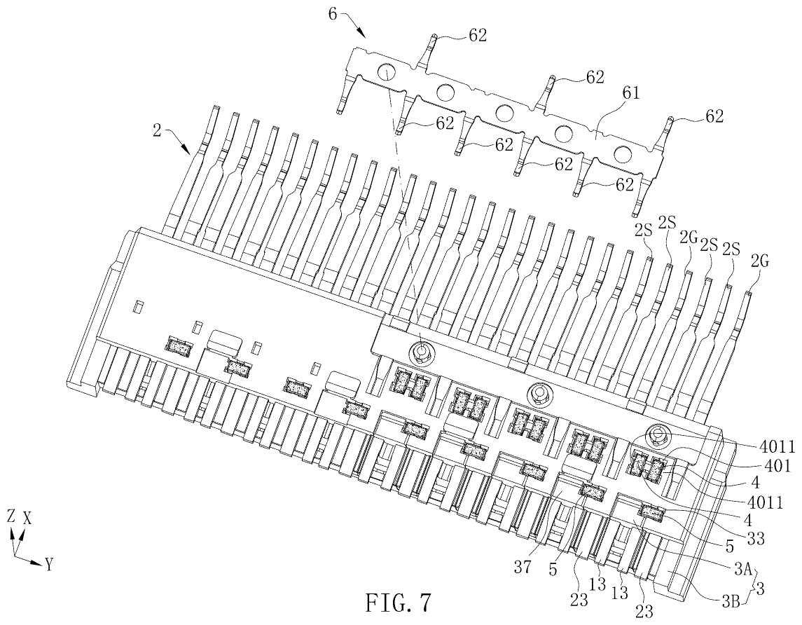

As shown in FIG. 7, in the first embodiment, the electronic components 4 are one-to-one correspondingly received in the openings 401 on the second plastic member 3B. As shown in FIG. 17, the inner wall surface of each opening 401 is protrudingly provided with a plurality of ribs 4011, and the ribs 4011 in each opening 401 are used to limit the corresponding electronic component 4 in both the front-rear direction X and the left-right direction Y.

As shown in FIG. 26 and FIG. 27, in the second embodiment, the electronic components 4 are one-to-one correspondingly received in the disposing slots 42. The inner wall surface of each disposing slot 42 is protrudingly provided with a plurality of protruding points 421 in the front-rear direction X and the left-right direction Y, and the protruding points 421 in the same disposing slot 42 are used to limit the corresponding electronic component 4 in both the front-rear direction X and the left-right direction Y.

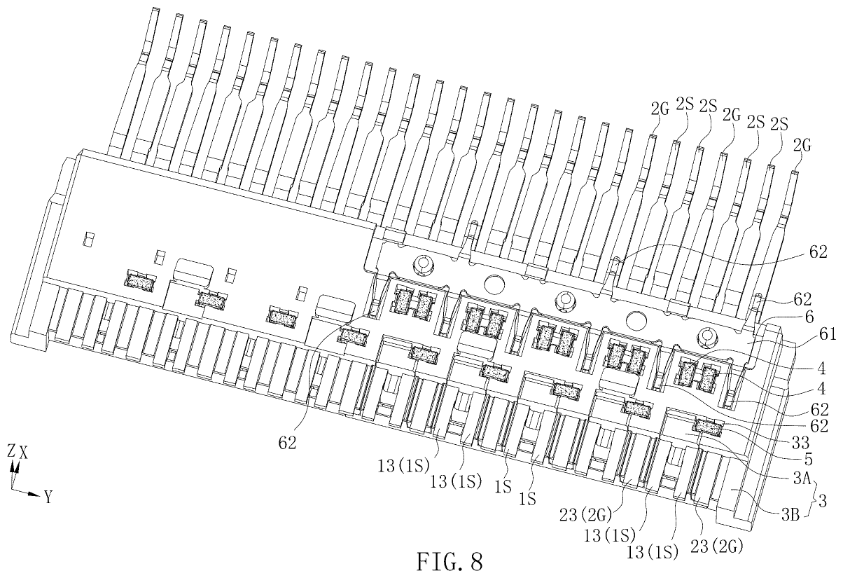

As shown in FIG. 5, FIG. 6 and FIG. 8, in the first embodiment, the electrostatic discharge protection components 5 are one-to-one correspondingly provided in the mounting slots 33, and each electrostatic discharge protection component 5 is soldered to the first body portion 11 of one of the pair of the first signal terminals 1S and the second body portion 21 of an adjacent grounding terminal 2G, thus preventing electrostatic interference. Specifically, each electrostatic discharge protection component 5 is a transient voltage suppressor (TVS). In other embodiments, each electrostatic discharge protection component 5 may be a Zener diode, a varistor, a gas discharge tube, or the like.

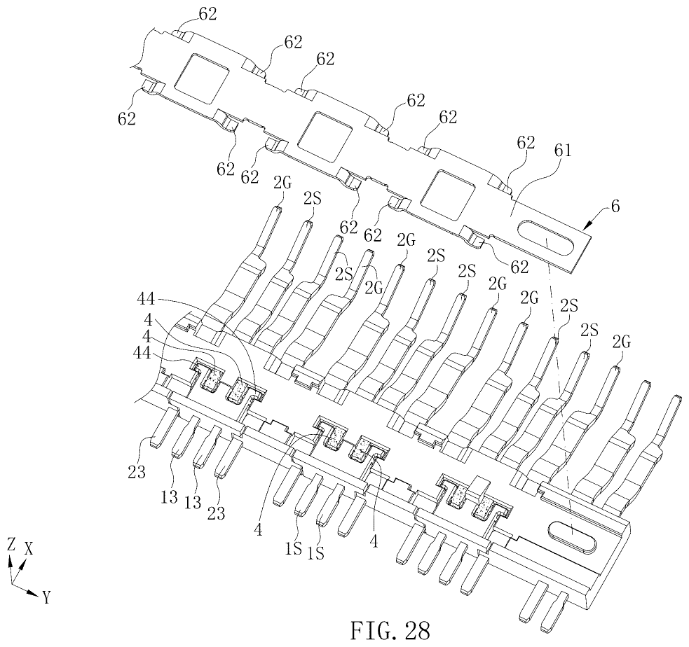

As shown in FIG. 7, FIG. 8 and FIG. 28, in the first embodiment and the second embodiment, the metal shielding sheet 6 includes a plate body 61 and a plurality of elastic arms 62. The plate body 61 is fixed to the second plastic member 3B, and the elastic arms 62 correspondingly abut against the grounding terminals 2G. Further, some of the grounding terminals 2G are in contact with two of the elastic arms 62.

As shown in FIG. 7 and FIG. 8, in the first embodiment, the plate body 61 is located in front of the electronic components 4. Some of the elastic arms 62 are formed by extending forward from the plate body 61, and some other elastic arms 62 are formed by extending backward from the plate body 61. Further, among the elastic arms 62 extending backward from the plate body 61, each two adjacent elastic arms 62 in the left-right direction Y respectively extend to a left side and a right side of a corresponding electronic component 4.

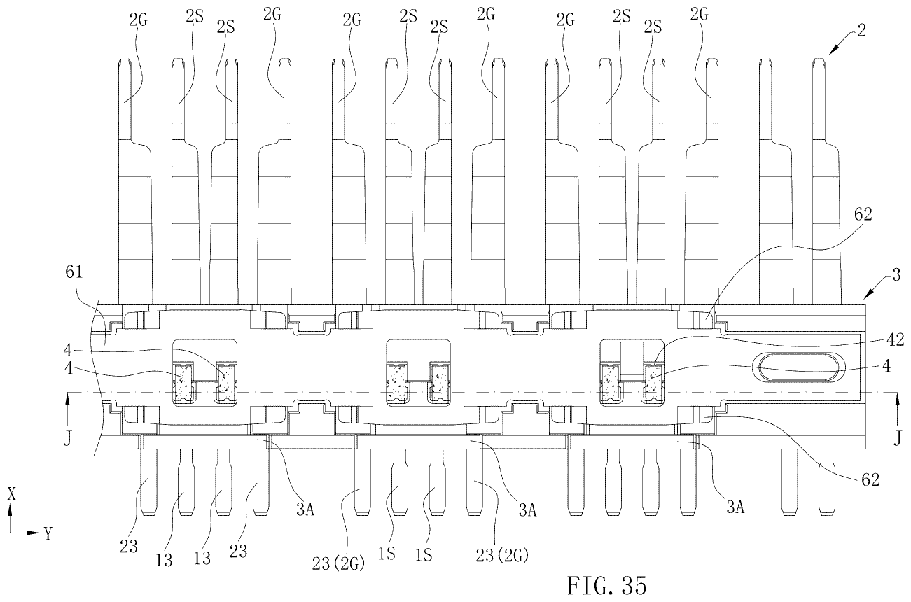

As shown in FIG. 29 and FIG. 35, in the second embodiment, the plate body 61 covers the main bodies 43 of the first plastic members 3A, thus allowing the plate body 61 to further stop the first plastic members 3A from detaching from the second plastic member 3B in the vertical direction Z.

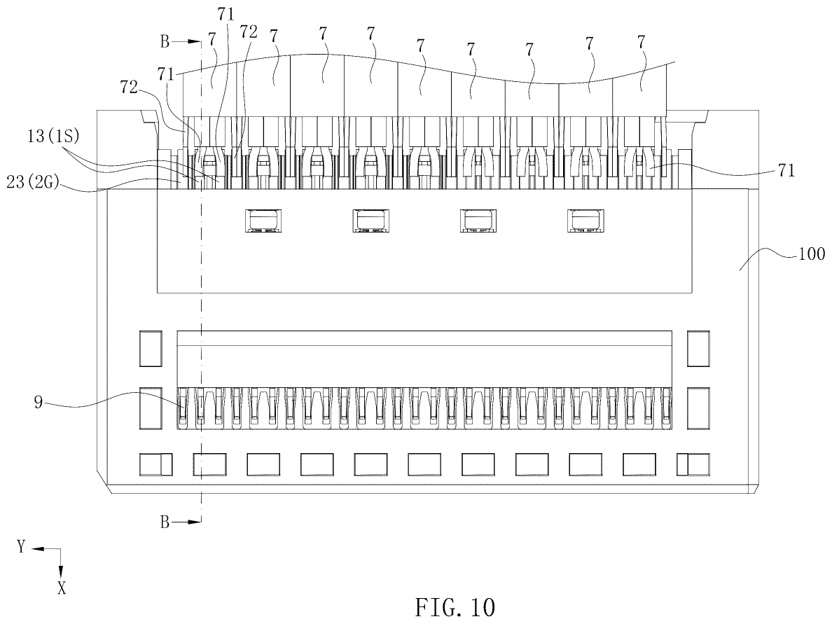

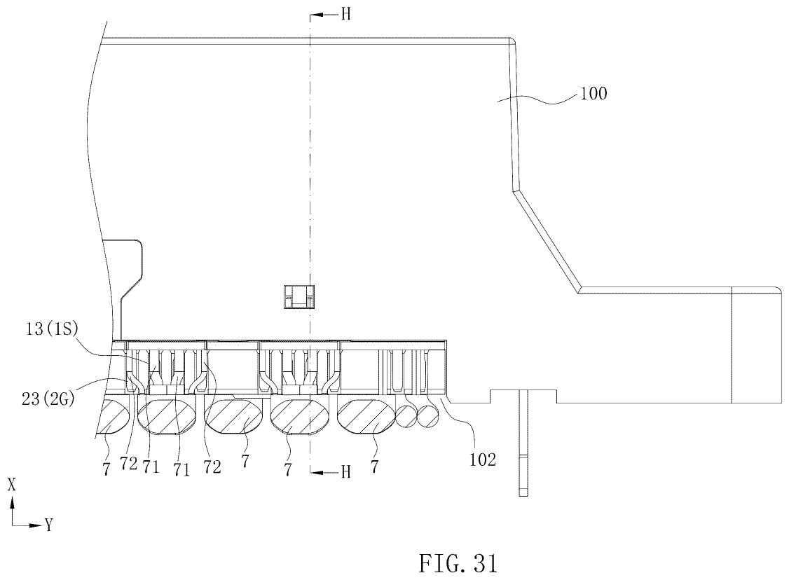

As shown in FIG. 9, FIG. 10, FIG. 30 and FIG. 31, in any of the two aforementioned embodiments, the first row of cables 7 include a plurality of first wires 71 and a plurality of second wires 72. The first wires 71 are one-to-one correspondingly soldered to the tail portions 13 of the first signal terminals 1S, and the second wires 72 are one-to-one correspondingly soldered to the second soldering portions 23 of the ground terminals 2G.

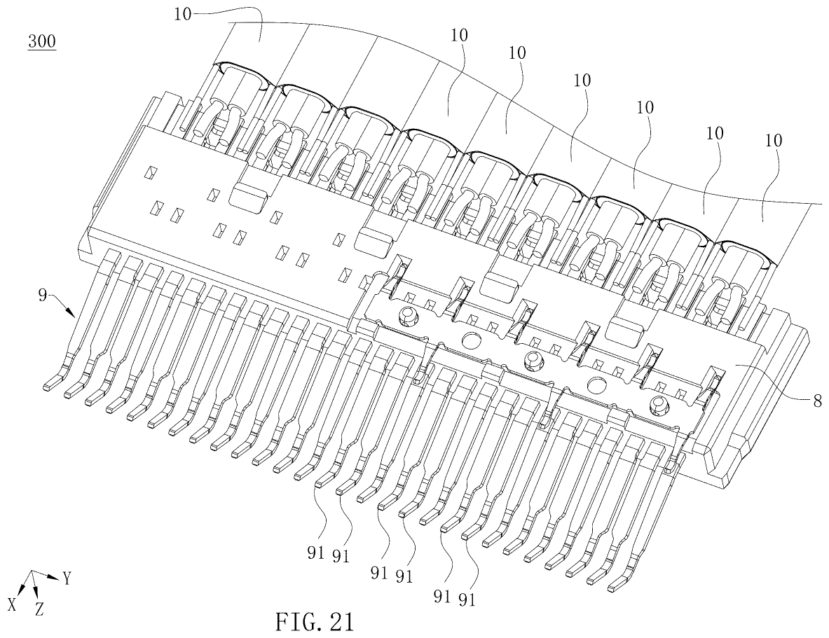

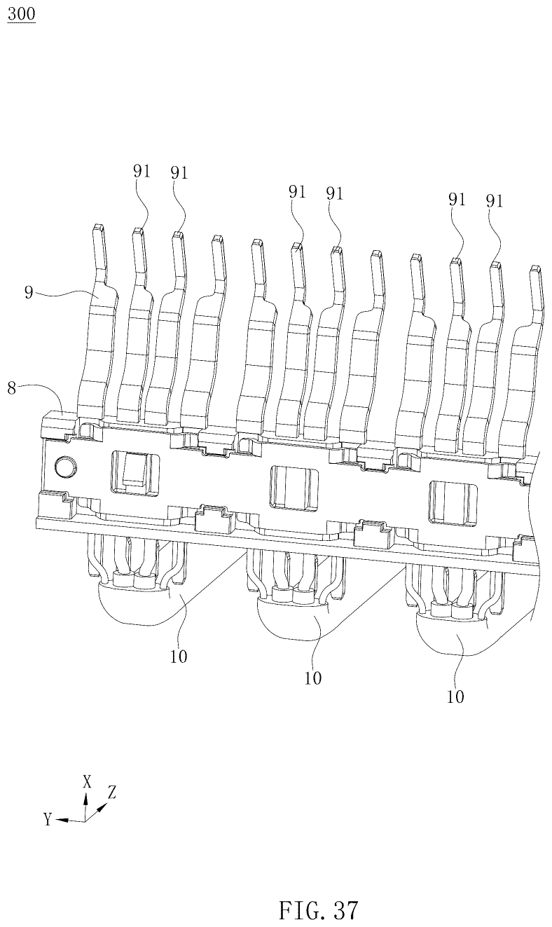

As shown in FIG. 21 and FIG. 37, in any of the two aforementioned embodiments, the terminal assembly 300 includes a terminal seat 8, a plurality of conduction terminals 9 and a second row of cables 10. The conduction terminals 9 are provided in the terminal seat 8 by insert-molding, and the second row of cables 10 are soldered to the rear ends of the conduction terminals 9.

As shown in FIG. 13, FIG. 21, FIG. 28 and FIG. 37, in any of the two aforementioned embodiments, the conduction terminals 9 include a plurality of pairs of third signal terminals 91. Specifically, each pair of the third signal terminals 91 are also used to transmit differential signals. Each first signal terminal 1S and a corresponding second signal terminal 2S as well as a corresponding electronic component 4 form a differential signal transmitting end, and each third signal terminal 91 forms a differential signal receiving end.

The method of manufacturing the terminal module 200 according to the first embodiment and the second embodiment of the present invention is described as follows:

As shown in FIG. 1 and FIG. 22, step 1: the first metal plate is processed by stamping to form a plurality of pairs of the first signal terminal 1S and a first strip 500 connected to the pairs of the first signal terminal 1S, and the second metal plate is processed by stamping to form the conductive terminals 2 and a second strip 600 connected to the conductive terminals 2. The second strip 600 is stamped to form a plurality of positioning holes 601. The first strip 500 is connected to the tail portions 13 of the pairs of the first signal terminals 1S. The second strip 600 is connected to the second soldering portions 23 of the conductive terminals 2. The conductive terminals 2 include a plurality of pairs of the second signal terminals 2S and a plurality of ground terminals 2G correspondingly provided at two opposite sides of each pair of the second signal terminals 2S.

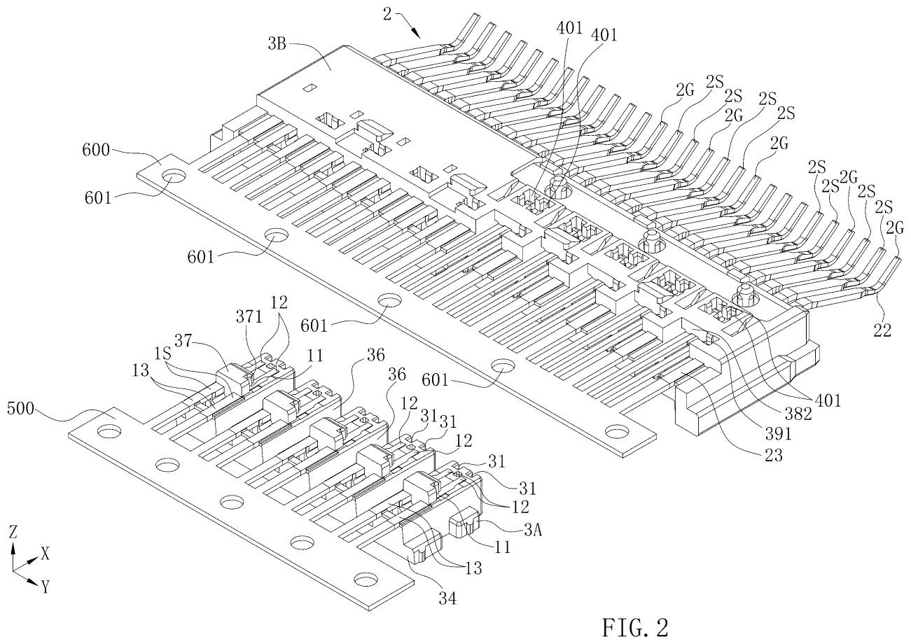

As shown in FIG. 2 and FIG. 22, step 2: in the first embodiment, molten plastic is insert-molded on the pairs of the first signal terminals 1S to form one first plastic member 3A, and molten plastic is insert-molded on the conductive terminals 2 to form one second plastic member 3B. The second embodiment is different from the first embodiment in that the insert-molding of the molten plastic is performed on each pair of the first signal terminals 1S to form one first plastic member 3A, such that a plurality of first plastic members 3A are correspondingly formed on the pairs of the first signal terminals 1S. That is, each first plastic member 3A is insert-molded with a pair of the first signal terminals 1S. In the first embodiment, the first plastic member 3A is provided with the positioning recesses 31, and the second plastic member 3B is provided with the openings 401 exposing the second soldering portions 23 of the second signal terminals 2S.

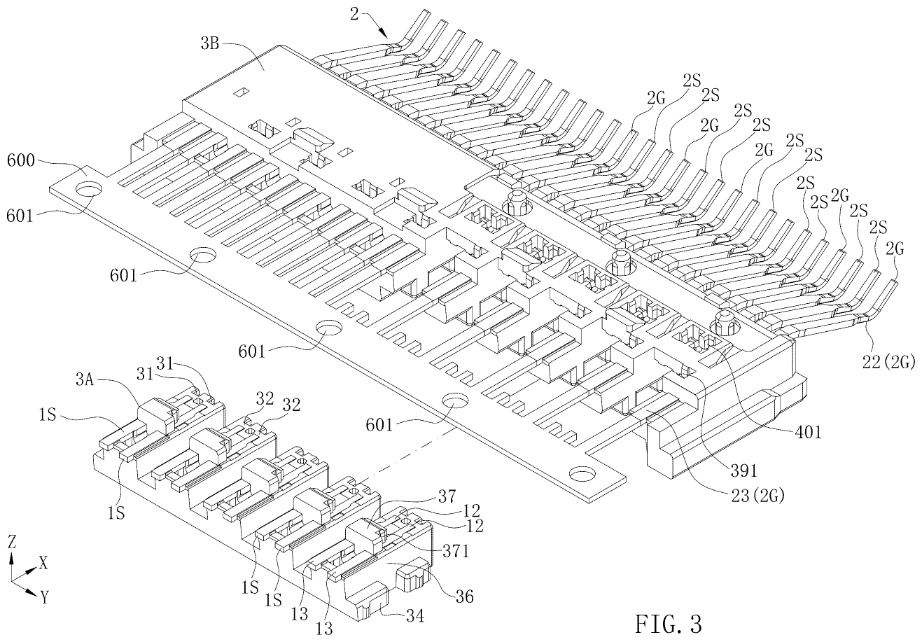

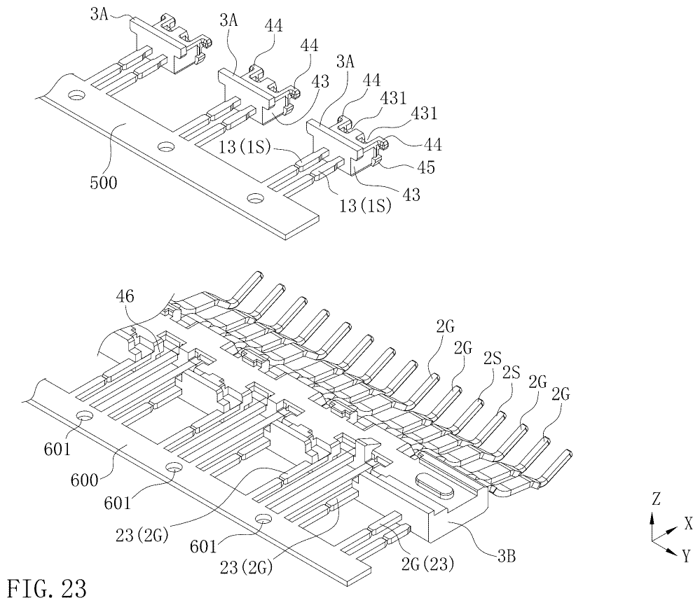

As shown in FIG. 3 and FIG. 23, step 3: in the first embodiment and the second embodiment, the connection locations between the first strip 500 and the pairs of the first signal terminals 1S are broken to remove the first strip 500, and the connection locations between the second strip 600 and the pairs of the second signal terminals 2S are broken. The connection locations between the second strip 600 and the ground terminals 2G are not broken, and the second strip 600 is reserved.

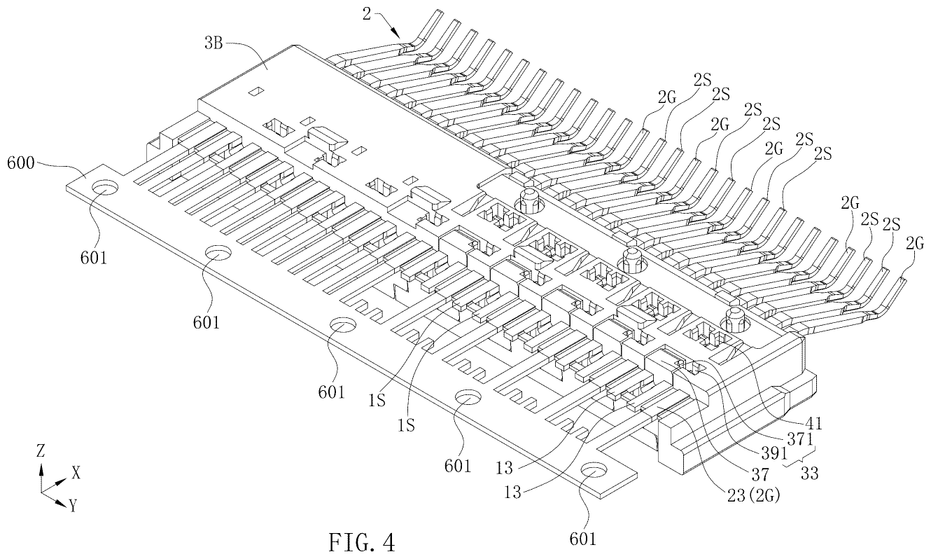

As shown in FIG. 4, FIG. 5, FIG. 24, FIG. 26 and FIG. 27, step 4: in the first embodiment and the second embodiment, using the positioning holes 601 on the second strip 600 as anchor points, the first plastic member 3A is assembled with the first signal terminals 1S onto the second plastic member 3B with the conductive terminals 2 and the second strip 600, such that an interval P is formed between the first soldering portion 12 of each first signal terminal 1S and the second soldering portion 23 of a corresponding second signal terminal 2S. In the first embodiment, as shown in FIG. 6, when mounting the first plastic member 3A and the second plastic member 3B, the second soldering portion 23 of each second signal terminal 2S is correspondingly placed on one of the positioning recesses 31, and each interval P is correspondingly exposed to one of the openings 401 in the vertical direction. In the second embodiment, specifically, the pairs of the first signal terminals 1S are provided according to a predetermined distance, such that after each pair of the first signal terminals 1S and the corresponding first plastic member 3A are insert-molded, the first plastic members 3A may be assembled onto the second plastic member 3B at one time. In other embodiments, the pairs of the first signal terminals 1S may be arranged more closely, such that the first plastic members 3A may be assembled onto the second plastic member 3B in multiple times.

As shown in FIG. 5, FIG. 6, FIG. 12, FIG. 26, FIG. 28 and FIG. 32, step 5: in the first embodiment and the second embodiment, using the positioning holes 601 on the second strip 600 as the anchor points, the electronic components 4 are one-to-one correspondingly soldered to the intervals P, and each electronic component 4 is electrically connected to each first signal terminal 1S and a corresponding second signal terminal 2S. In the first embodiment, the electronic components 4 are provided to one-to-one correspond to the intervals P through the openings 401, and each of the electrostatic discharge protection components 5 is correspondingly soldered between one first signal terminal 1S of each pair of the first signal terminals 1S and an adjacent grounding terminal 2G, thus eliminating the electrostatic interference.

As shown in FIG. 5, FIG. 7, FIG. 26 and FIG. 28, step 6: in the first embodiment and the second embodiment, the second strip 600 is broken from the remaining conductive terminals 2, and the second strip 600 is removed.

As shown in FIG. 7, FIG. 8, FIG. 28 and FIG. 29, step 7: in the first embodiment and the second embodiment, the metal shielding sheet 6 is mounted on the second plastic member 3B.

As shown in FIG. 9, FIG. 10, FIG. 30 and FIG. 31, step 8: in the first embodiment and the second embodiment, in the first row of cables 7, the first wires 71 are one-to-one correspondingly soldered to the tail portions of the first signal terminals 1S, and the second wires 72 are one-to-one correspondingly soldered to the second soldering portions 23 of the ground terminals 2G, thus forming the terminal module 200.

The present invention has the following beneficial effects:
1. In the present invention, the first signal terminal 1S and the second signal terminal 2S are formed individually, and the first soldering portion 12 of the first signal terminal 1S and the second soldering portion 23 of the second signal terminal 2S are provided to be separated to form the interval P. That is, there is no need to cut the middle portion of the entire signal terminals with a cutting tool to form the interval P therebetween, thus facilitating the manufacturing of the terminal module 200.
2. Compared to the case where a machine is used to fix the second plastic member 3B, the positioning holes 601 on the second strip 600 are used as positioning anchor points, thus facilitating more accurate mounting of the first plastic member 3A onto the second plastic member 3B, and also facilitating more accurate mounting of the electronic components 4.
3. The positioning recesses 31 are used to facilitate the accurate positioning of the first soldering portions 12 of the first signal terminals 1S and the second soldering portions 23 of the corresponding second signal terminals 2S, thereby facilitating the soldering of the electronic components 4.
4. Each separation block 32 is provided between one of the first soldering portions 12 and the second soldering portion 23 of a corresponding second signal terminal 2S, thus allowing the interval P between each first soldering portion 12 and the second soldering portion 23 of the corresponding second signal terminal 2S to be formed within a predetermined range in the front-rear direction X, and facilitating the alignment soldering of the first mating portion 4a and the second mating portion 4b of each electronic component 4.
5. The height of the upper surface of each separation block 32 is not higher than the first soldering surface 121 of the first signal terminal 1S and the second soldering surface 231 of the corresponding second signal terminal 2S, thus preventing stopping of the soldering of the electronic component 4.
6. To increase the soldering area of the first soldering portion 12 and the second soldering portion 23 of the corresponding second signal terminal 2S for better soldering of the electronic component 4, the third soldering surfaces 122 are provided on the left and right surfaces of the first soldering portion 12, and the fourth soldering surfaces 232 are provided on the left and right surfaces of the second soldering portion 23 of the corresponding second signal terminal 2S. Meanwhile, the third soldering surfaces 122 and the fourth soldering surfaces 232 are exposed on a surface of the plastic seat 3 in the vertical direction Z, such that when spray-coating the solder, in addition to the first soldering surface 121 being connected to the first mating portion 4a by the solder and the second soldering surface 231 being connected to the second mating portion 4b by the solder, the third soldering surfaces 122 may also be connected to the first mating portion 4a by the solder, and the fourth soldering surfaces 232 may also be connected to the second mating portion 4b by the solder.
7. The openings 401 are provided to one-to-one correspond to the intervals P, thus facilitating the precise soldering of the electronic components 4 onto the corresponding first soldering portions 12 and the second soldering portions 23 of the second signal terminals 2S through the openings 401.
8. The electrostatic discharge protection components 5 are used to dissipate the electrostatic energy, thereby preventing the electrostatic interference of the connector assembly.
9. The first plastic member 3A is embedded within the second plastic member 3B, and the first plastic member 3A does not pass beyond the second plastic member 3B in the front-rear direction X, thus facilitating miniaturization of the terminal module 200.
10. The protruding portions 36 of the first plastic member 3A are one-to-one correspondingly received in the receiving slots 38 of the second plastic member 3B. The first slot 381 stops a side of the first solder portion 12 of the first signal terminal 1S in the vertical direction Z, such that the first solder portion 12 of the first signal terminal 1S and the second solder portion 23 of the corresponding second signal terminal 2S are flush in the vertical direction Z, which is conducive to soldering of the electronic component 4. The second slot 382 exposes the tail end 13 of the first signal terminal 1S, thus facilitating the soldering of the first wire 71 in the first row of cables 7.
11. The second soldering portion 23 of each grounding terminal 2G extends to the corresponding separation wall 39 and is provided to be side-by-side with the tail portion 13 of the corresponding first signal terminal 1S along the left-right direction Y, thus facilitating the synchronous soldering of the first wire 71 and the second wire 72 of the first row of cables 7 to the first signal terminal 1S and the grounding terminal 2G.
12. The positioning slots 35 of the first plastic member 3A and the positioning posts 41 of the second plastic member 3B engage with each other in the vertical direction Z, and the assembling method is simple and reliable.
13. Compared to the case where the mounting slots 33 are provided at the portions where the first signal terminal 1S and its adjacent grounding terminal 2G are directly exposed, each mounting slot 33 is provided to run through the plastic seat 3. On one hand, it may limit and protect the electrostatic discharge protection component 5 in the front-rear direction X and the left-right direction Y, and on the other hand, it is conducive to the alignment soldering of the electrostatic component with the first signal terminal 1S and its adjacent grounding terminal 2G.
14. Each disposing slot 42 has a portion formed in the first plastic member 3A and another portion formed in the second plastic member 3B. By simply mating the first plastic member 3A with the second plastic member 3B, the disposing slots 42 are formed therebetween, such that the first solder portion 12 and the second solder portion 23 of the corresponding second signal terminal 2S may be aligned and exposed within the corresponding disposing slot 42. Compared to the first embodiment, it avoids the need to form the openings 401 in the second plastic member 3B.
15. The metal shielding sheet 6 covers the sides of the first plastic members 3A away from the terminal assembly 300 in the vertical direction Z, thus allowing the matching with the second plastic member 3B to stop the first plastic members 3A from detaching from the second plastic member 3B in the vertical direction Z.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method of manufacturing a terminal module, the method comprising:
S1: providing at least one first signal terminal and a plurality of conductive terminals having at least one second signal terminal, and providing at least one first plastic member and a second plastic member, wherein each of the at least one first signal terminal comprises a first body portion and a first soldering portion and a tail portion provided at two opposite ends of the first body portion, and each of the conductive terminals comprises a second body portion and a contact portion and a second soldering portion provided at two opposite ends of the second body portion;
S2: mounting the first signal terminal in the first plastic member, such that the first soldering portion and the tail portion are exposed outside the first plastic member, and mounting the conductive terminals in the second plastic member, such that the second soldering portion of each of the conductive terminals is exposed outside the second plastic member;
S3: connecting and fixing the first plastic member mounted with the first signal terminal and the second plastic member mounted with the conductive terminals, such that the first soldering portion of each of the at least one first signal terminal one-to-one aligns with the second soldering portion of a corresponding one of the at least one second signal terminal along a first direction, and an interval is formed between the first soldering portion and the corresponding second soldering portion; and
S4: disposing each of an electronic component to correspond to one of the interval, wherein the electronic component has a first mating portion and a second mating portion, and soldering the first mating portion to the first soldering portion, and soldering the second mating portion to the second soldering portion of the corresponding one of the at least one second signal terminal.

2. The method according to claim 1, further comprising:
providing a first metal plate and a second metal plate;
stamping the first metal plate to form the at least one first signal terminal and a first strip connected to the first signal terminal;
stamping the second metal plate to form the conductive terminals and a second strip connected to the conductive terminals;
insert-molding molten plastic on the first signal terminal to form the first plastic member; and
insert-molding molten plastic on the conductive terminals to form the second plastic member.

3. The method according to claim 2, further comprising:
after the step S1 and prior to the step S2, breaking the first strip and the first signal terminal to remove the first strip, and breaking the second strip and the second signal terminal; and
by positioning of the second strip, assembling the first plastic member with the first signal terminal to the second plastic member with the conductive terminals and the second strip, then soldering the electronic component between the first soldering portion and the second soldering portion of the corresponding one of the at least one second signal terminal, and finally breaking the second strip and the remaining conductive terminals to remove the second strip.

4. The method according to claim 1, further comprising: assembling the first plastic member with the first signal terminal to the second plastic member with the conductive terminals, such that the second soldering portion of the second signal terminal is disposed on the first plastic member.

5. The method according to claim 4, wherein the first plastic member is provided with at least one positioning recess, and in the step S2, the second soldering portion of the second signal terminal protrudes into the positioning recess, such that the second soldering portion of the second signal terminal aligns with the corresponding first soldering portion in the first direction.

6. The method according to claim 1, wherein the second plastic member is provided with at least one opening, the opening runs through a side of the second plastic member along a second direction, the second direction is perpendicular to the first direction, each of the at least one opening is provided to correspond to the interval in the second direction, such that the first soldering portion and the second soldering portion of the corresponding one of the at least one second signal terminal are exposed in the corresponding opening, and the electronic component is disposed in the opening.

7. The method according to claim 1, wherein:
in the step S1, the conductive terminals further have a plurality of ground terminals correspondingly provided at two opposite sides of the at least one second signal terminal, the ground terminals extend to pass beyond the second soldering portion of the second signal terminal and extend toward the first signal terminal to an adjacent side of the first signal terminal; and
in the step S4, at least one electrostatic discharge protection component is provided, and each of the at least one electrostatic discharge protection component is soldered to a corresponding one of the at least one first signal terminal and one of the ground terminals adjacent to the corresponding one of the at least one first signal terminal.

8. The method according to claim 1, comprising:
providing a plurality of pairs of first signal terminals and a plurality of pairs of second signal terminals, wherein each pair of the first signal terminals and a corresponding pair of the second signal terminals are configured to transmit differential signals, each pair of the first signal terminals are insert-molded with molten plastic to form one of the first plastic members, and each of the first plastic members is assembled to the second plastic member.

9. The method according to claim 1, further comprising: providing a plurality of first wires, wherein after soldering the electronic component to the first soldering portion and the corresponding second soldering portion, the first wires are soldered to the tail portion of the first signal terminal.

10. A connector assembly, comprising:
a housing; and
a terminal module, provided in the housing;
wherein the terminal module comprises:
at least one first signal terminal and a plurality of conductive terminals comprising at least one second signal terminal and a plurality of ground terminals, wherein the first signal terminal and the second signal terminal are formed individually, each of the at least one first signal terminal comprises a first body portion and a first soldering portion and a tail portion provided at two opposite ends of the first body portion, and each of the conductive terminals comprises a second body portion and a contact portion and a second soldering portion provided at two opposite ends of the second body portion;
a plastic seat, wherein the first signal terminal and the second signal terminal are both mounted in the plastic seat, the first soldering portion of the first signal terminal aligns with the second soldering portion of a corresponding one of the at least one second signal terminal along a first direction, and an interval is formed between the first soldering portion and the corresponding second soldering portion; and
at least one electronic component, correspondingly provided at one of the interval, wherein the electronic component has a first mating portion and a second mating portion, the first mating portion is soldered to the first soldering portion, and the second mating portion is soldered to the second soldering portion.

11. The connector assembly according to claim 10, wherein:
the plastic seat is provided with at least one positioning recess;
the plastic seat comprises at least one first plastic member and a second plastic member mounted to each other, the first signal terminal is provided in the first plastic member by insert-molding, and the conductive terminals are provided in the second plastic member by insert-molding; and
the positioning recess is formed on the first plastic member, and the second soldering portion of each of the at least one second signal terminal one-to-one correspondingly protrude into a corresponding one of the at least one positioning recess; or the positioning recess is formed on the second plastic member, and the first soldering portion of each of the at least one first signal terminal one-to-one correspondingly protrude into a corresponding one of the at least one positioning recess.

12. The connector assembly according to claim 10, wherein the plastic seat is provided with one of a plurality of separation blocks corresponding to each of the intervals, each of the separation blocks protrudes into a corresponding one of the intervals, such that the separation blocks separate the first soldering portion and the second soldering portion of the corresponding one of the at least one second signal terminal in the first direction.

13. The connector assembly according to claim 12, wherein the first direction is defined as a front-rear direction, an upper surface of the first soldering portion is a first soldering surface configured to be soldered to the first mating portion, an upper surface of the second soldering portion of the corresponding one of the at least one second signal terminal is a second soldering surface configured to be soldered to the second mating portion, and an upper surface of each of the separation blocks is provided to be not higher than the first soldering surface and the second soldering surface.

14. The connector assembly according to claim 10, wherein:
a plurality of pairs of first signal terminals and a plurality of pairs of second signal terminals are provided, the plastic seat comprises a first plastic member and a second plastic member mounted to each other, the first signal terminals are provided in the first plastic member, the conductive terminals are provided in the second plastic member, the first direction is defined as a front-rear direction, the first soldering portion is located behind the second soldering portion of a corresponding one of the second signal terminals, the second plastic member is provided with a plurality of receiving slots, each of the receiving slots corresponds to each pair of the first signal terminals, the receiving slots run backward through the second plastic member, a separation wall is provided at each of a left side and a right side of each of the receiving slots, and portions of the ground terminals extend from the separation walls at the left side and the right side of each of the receiving slots; and
the first plastic member comprises a base body and a plurality of protruding portions protrudingly provided relative to the base body, the protruding portions are correspondingly accommodated in the receiving slots, and a portion of each pair of the first signal terminals are mounted in a corresponding one of the protruding portions.

15. The connector assembly according to claim 14, wherein each of the receiving slots comprises a first slot and a second slot located behind the first slot, the second slot runs through the second plastic member backward and along the vertical direction, the first slot runs through one side of the second plastic member in the vertical direction, the second plastic member is provided with a separation plate at another side of the first slot in the vertical direction, the separation plate is provided with two openings, the openings run vertically through the separation plate and are in communication with the first slot, the first slot accommodates the first soldering portion and the second soldering portion of the corresponding one of the second signal terminals, the openings allows the first soldering portion and the second soldering portion of the corresponding one of the second signal terminals to expose in a corresponding one of the openings in the vertical direction, and the electronic component is received in the openings.

16. The connector assembly according to claim 10, wherein the ground terminals extend to pass beyond the second soldering portion of a corresponding one of the at least one second signal terminal and extend toward the first signal terminal to an adjacent side of the first signal terminal, the connector assembly further comprises at least one electrostatic discharge protection component, and the electrostatic discharge protection component is soldered to a corresponding one of the at least one first signal terminal and one of the ground terminals adjacent to the corresponding one of the at least one first signal terminal.

17. The connector assembly according to claim 16, wherein the first direction is defined as a front-rear direction, the plastic seat is provided with a plurality of mounting slots, each of the mounting slots runs through a side of the plastic seat along the vertical direction, a portion of the first signal terminal and a portion of the one of the ground terminals adjacent thereto are exposed by one of the mounting slots, and each of the at least one electrostatic discharge protection component is correspondingly provided in a corresponding one of the mounting slots.

18. The connector assembly according to claim 10, wherein a plurality of pairs of first signal terminals and a plurality of pairs of second signal terminals are provided, the plastic seat comprises a plurality of first plastic members and a second plastic member, the first plastic members are assembled on the second plastic member, each pair of the first signal terminals are provided in one of the first plastic member, the conductive terminals are provided in the second plastic member, each of the first plastic members and the second plastic member collectively form a pair of disposing slots, each pair of the disposing slots run through a respective side of a corresponding one of the first plastic members and a respective side of the second plastic member in a vertical direction, the vertical direction is perpendicular to the first direction, the disposing slots correspondingly expose the first soldering portions and the second soldering portions of the second signal terminals, and the electronic components are disposed in the disposing slots.

19. The connector assembly according to claim 10, wherein the electronic component is a surface-mount capacitor, and the first signal terminals and the second signal terminals soldered to the electronic component are signal transmitting ends of high frequency signals.

20. A connector assembly, comprising:
a housing; and
a terminal module, provided in the housing;
wherein the terminal module comprises:
at least one pair of first signal terminals and a plurality of conductive terminals comprising at least one pair of second signal terminals and a plurality of ground terminals, wherein the first signal terminals and the second signal terminals are formed individually, each of the at least one first signal terminal comprises a first body portion and a first soldering portion and a tail portion provided at two opposite ends of the first body portion, each of the conductive terminals comprises a second body portion and a contact portion and a second soldering portion provided at two opposite ends of the second body portion, and each pair of the first signal terminals and a corresponding pair of the second signal terminals are configured to transmit differential signals;
a plastic seat, wherein the first signal terminals and the second signal terminals are both mounted in the plastic seat, the first soldering portion of each of the first signal terminals aligns with the second soldering portion of a corresponding one of the second signal terminals along a first direction, and an interval is formed between the first soldering portion and the corresponding second soldering portion; and
at least one capacitor, correspondingly provided at one of the interval, wherein the capacitor has a first mating portion and a second mating portion, the first mating portion is soldered to the first soldering portion, and the second mating portion is soldered to the second soldering portion.
